(19) United States
(12) Patent Application Publication
(10) Pub. No.: US 2014/0025909 A1
(43) Pub. Date: Jan. 23, 2014

(54) LARGE SCALE STORAGE SYSTEM

(71) Applicant: STORONE LTD., Ra'Anana (IL)

(72) Inventors: Gal NAOR, Givet Shmuel (IL); Raz GORDON, Hadera (IL)

(21) Appl. No.: 13/938,336

(22) Filed: Jul. 10, 2013

Related U.S. Application Data
(60) Provisional application No. 61/669,841, filed on Jul. 10, 2012.

(51) Int. Cl. G06F 3/06

(52) U.S. Cl. CPC G06F 3/0641; G06F 3/0619; G06F 3/067
USPC 711/162

(57) ABSTRACT

One or more tangible computer readable media storing computer executable instructions that, when executed by a processor, cause a computer node connected to an infrastructure layer of a distributed storage system, the infrastructure layer including interconnected computer nodes, at least one of the interconnected computer nodes comprising one or more storage-related resources, to perform administration of a distributed storage system by: generating at least one portion of a user interface for presentation to a user, each of the portions comprising a control for receiving a Service Level Specification (SLS) requirement; transforming a state of the distributed storage system from a first state to a second state based on the received SLS requirements.

### CROSS-REFERENCE TO RELATED APPLICATIONS

This application claims priority to provisional U.S. Application Ser. No. 61/669,841, filed Jul. 10, 2012, having the title “LARGE SCALE STORAGE SYSTEM”, herein incorporated by reference in its entirety for all purposes.

### FIELD OF THE PRESENTLY DISCLOSED SUBJECT MATTER

The invention relates to large scale storage systems and in particular to an apparatus and a method for implementing such systems.

### BACKGROUND

Distributed storage systems have rapidly developed over the last decade as networks grow in capacity and speed. With networks expanding from local area networks (LAN) to global wide area networks (WAN), businesses are becoming more globally distributed, resulting in a demand for distributed storage systems to provide data storage and access over remote geographic locations. There is thus a need in the art for a new method and system for distributing data storage over a general purpose network.

Prior art references considered to be relevant as background to the presently disclosed subject matter are listed below. Acknowledgement of the references herein is not to be inferred as meaning that these are in any way relevant to the patentability of the presently disclosed subject matter.

U.S. Patent Publication No. 2009/0070337, “Apparatus and Method for a Distributed Storage Global Database”, relates to “A geographically distributed storage system for managing the distribution of data elements wherein requests for given data elements incur a geographic inertia. The geographically distributed storage system comprises geographically distributed sites, each comprises a site storage unit for locally storing a portion of a globally coherent distributed database that includes the data elements and a local access point for receiving requests relating to ones of the data elements. The geographically distributed storage system comprises a data management module for forwarding at least one requested data element to the local access point at a first of the geographically distributed sites from which the request is received and storing the at least one requested data element at the first site, thereby to provide local accessibility to the data element for future requests from the first site while maintaining the globally coherency of the distributed database.”

U.S. Pat. No. 5,987,505, “Remote Access and Geographically Distributed Computers in a Globally Addressable Storage Environment”, relates to “A computer system employs a globally addressable storage environment that allows a plurality of networked computers to access data by addressing even when the data is stored on a persistent storage device such as a computer hard disk and other traditionally non-addressable data storage devices. The computers can be located on a single computer network or on a plurality of interconnected computer networks such as two local area networks (LANs) coupled by a wide area network (WAN). The globally addressable storage environment allows data to be accessed and shared by and among the various computers on the plurality of networks.”

International Journal of Computer Applications 2010 (0975-8887), Volume 1-No. 22, “Unified Virtual Storage: Virtualization of Distributed Storage in a Network”, Ms. S. V. Patil et al., describes “a way to efficiently utilize free disk space on Desktop machines connected over a network. In many networks today, the local disks of a client node are only used sporadically. This is an attempt to mange the data storages in a network efficiently and to provide the software support for sharing of disk space on Desktop machines in LAN. In the current situation, storage expansion on conventional servers has constraints like, maximum expansion limitation, costly affair and in case of hardware replacement, up gradation, the manual relocation of Data becomes messy. UVS (Unified Virtual Storage) is an attempt to efficiently utilize freely available disk space on Desktop machines connected over a network. Its purpose to reduce load of data traffic on network server, to efficiently utilize space on client nodes thereby avoiding wastage of space, It also eliminates Hardware restriction for storage Expansion and provides Location transparency of data store. The main advantage of UVS is that it can be seamlessly integrated into the existing infrastructure (Local Area Network system). Virtual Storage is virtually infinite supporting scalable architecture. The client node can use the Unified Virtual Drive as a single point access for Distributed Storage across different servers thereby eliminating an individual addressing of the servers. The performance of prototype implemented on a UVS Server connected by network and performance is better the n the centralized system and that the overhead of the framework is moderate even during high load.”

U.S. Patent Publication No. 2011/0153770, “Dynamic Structural Management of a Distributed Caching Infrastructure”, relates to “a method, system and computer program product for the dynamic structural management of an n-Tier distributed caching infrastructure. In an embodiment of the invention, a method of dynamic structural management of an n-Tier distributed caching infrastructure includes establishing a communicative connection to a plurality of cache servers arranged in respective tier nodes in an n-Tier cache, collecting performance metrics for each of the cache servers in the respective tier nodes of the n-Tier cache, identifying a characteristic of a specific cache resource in a corresponding one of the tier nodes of the n-Tier crossing a threshold, and dynamically structuring a set of cache resources including the specific cache resource to account for the identified characteristic”.

### SUMMARY

In accordance with a certain aspect of the presently disclosed subject matter, there is provided one or more tangible computer readable media storing computer executable instructions that, when executed by a processor, cause a computer node connected to an infrastructure layer of a distributed storage system, said infrastructure layer including interconnected computer nodes, at least one of said interconnected computer nodes comprising one or more storage-related resources, to perform administration of a distributed storage system by: generating at least one portion of a user interface for presentation to a user, each of said portions comprising a control for receiving a Service Level Specification (SLS) requirement, wherein one or more of said SLS requirements relate to a distinct one of the following: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies; transforming a state of the distributed storage system from a first state to a second state based on the received SLS requirements.

In accordance with certain examples of the presently disclosed subject matter, there is further provided a computer readable media wherein said transforming comprises: calculating a reconfiguration for the distributed storage system, based, at least, on said SLS requirements; and automatically allocating at least part of one of said storage-related resources according to the calculated reconfiguration.

In accordance with certain examples of the presently disclosed subject matter, there is further provided a computer readable media wherein said computer executable instructions further cause the computer node to perform administration of the distributed storage system by: outputting the at least one portion for display to the user; and receiving user input defining values for each of the SLS requirements.

In accordance with certain examples of the presently disclosed subject matter, there is further provided a computer readable media, wherein outputting comprises outputting the at least one portion for display to the user in a single user interface, and wherein the received SLS requirements are received via the single user interface.

In accordance with a certain aspect of the presently disclosed subject matter, there is provided a Distributed Storage System (DSS) comprising at least two logical storage entities, wherein each logical storage entity is configured in accordance with Service Level Specification (SLS) requirements, and wherein the DSS is configured to a first state, wherein a first logical storage entity is associated with first SLS requirements, and wherein a second logical storage entity is associated with second SLS requirements; the DSS further comprising: an infrastructure layer including interconnected computer nodes, wherein: each one of said interconnected computer nodes comprising at least one processing resource configured to execute a Unified Distributed Storage Platform (UDSP) agent; at least one of said interconnected computer nodes comprising one or more storage-related resources; said UDSP agent is configured to: receive an input defining third SLS requirements, wherein said inputs is received via a configuration user interface that displays a plurality of input controls, each input control corresponding to an SLS requirement of said SLS requirements, wherein at least one of said SLS requirements relate to a distinct one of the following: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies; and automatically transform the distributed storage system to a second state, wherein the first logical storage entity is configured in accordance with the third SLS requirements, and wherein the second logical storage entity is configured in accordance with the second SLS requirements.

In accordance with certain examples of the presently disclosed subject matter, there is further provided a system wherein the configuration user interface concurrently displays the plurality of input controls.

In accordance with a certain aspect of the presently disclosed subject matter, there is provided a method of operating a computer node configured to being connected to an infrastructure layer of a distributed storage system (DSS) configured to a first state, said infrastructure layer including interconnected computer nodes, at least one of said interconnected computer nodes comprising one or more storage-related resources, wherein said DSS provides storage service to a plurality of users, wherein the storage service for each of the users is provided in accordance with a plurality of Service Level Specification (SLS) requirements, the method comprising: receiving user input defining an updated value for one or more of the plurality of SLS requirements associated with a first user of the plurality of users; and automatically transforming the distributed storage system to a second state wherein the storage service of the first user is modified based on the received user input, and wherein the storage service of a second user remains unchanged from the first state.

In accordance with certain examples of the presently disclosed subject matter, there is further provided a method wherein said transforming comprises: calculating a reconfiguration for the distributed storage system, based, at least, on the received user input; and automatically allocating at least part of one of said storage-related resources according to the calculated reconfiguration.

In accordance with certain examples of the presently disclosed subject matter, there is further provided a method wherein the plurality of SLS requirements comprise one or more of: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 schematically illustrates a top-level architecture of a Distributed Storage System including an Infrastructure Layer, according to an exemplary embodiment of the invention;

FIG. 2 schematically illustrates a simplified, exemplary system for configuring a Distributed Storage System, according to the presently disclosed subject matter;

FIG. 3 schematically illustrates a simplified and exemplary flow diagram of an optimization process performed by the objective-based management system, according to the presently disclosed subject matter;

FIG. 4 schematically illustrates a simplified flow diagram of an exemplary operational algorithm of a configuration process performed by the objective-based management system, according to the presently disclosed subject matter;

FIG. 5 is a block diagram schematically illustrating an exemplary computer node connected to the Distributed Storage System, according to certain examples of the presently disclosed subject matter;

FIG. 6 is a flowchart illustrating a sequence of operations carried out for creating a task, according to certain examples of the presently disclosed subject matter;

FIG. 7 is a flowchart illustrating a sequence of operations carried out for creating an exemplary storage block-write task, according to certain examples of the presently disclosed subject matter.

FIG. 8 is a flowchart illustrating a sequence of operations carried out for managing a task received by a UDSP agent, according to certain examples of the presently disclosed subject matter;

FIG. 9 is a flowchart illustrating a sequence of operations carried out for grading nodes suitability to execute pending task assignments, according to certain examples of the presently disclosed subject matter;

FIG. 10 is a flowchart illustrating a sequence of operations carried out for executing pending assignments on a computer node, according to certain examples of the presently disclosed subject matter

FIG. 11 is a flowchart illustrating a sequence of operations carried out for managing reconfigurations of Distributed Storage System (DSS), according to certain examples of the presently disclosed subject matter;

FIG. 12 is a flowchart illustrating a sequence of operations carried out for monitoring local parameters of a computer node and resources connected thereto, according to certain examples of the presently disclosed subject matter;

FIG. 13 is a flowchart illustrating a sequence of operations carried out for detecting and managing resources connected to a computer node, according to certain examples of the presently disclosed subject matter;

FIG. 14 is a flowchart illustrating a sequence of operations carried out for connecting a new computer node to Distributed Storage System (DSS), according to certain examples of the presently disclosed subject matter;

FIG. 15 is a flowchart illustrating a sequence of operations carried out for receiving a notification from a remote computer node and updating a Unified Distributed Storage Platform (UDSP) data repository accordingly, according to certain examples of the presently disclosed subject matter;

FIG. 16 is a flowchart illustrating a sequence of operations carried out for generating a user interface for receiving user input defining Service Level Specification (SLS) requirements and configuring a Distributed Storage System (DSS) accordingly, according to certain examples of the presently disclosed subject matter;

FIG. 17 is an illustration of an exemplary user interface used for administration of a distributed storage system, according to the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “calculating”, “executing”, “routing”, “monitoring”, “propagating”, “allocating”, “providing” or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

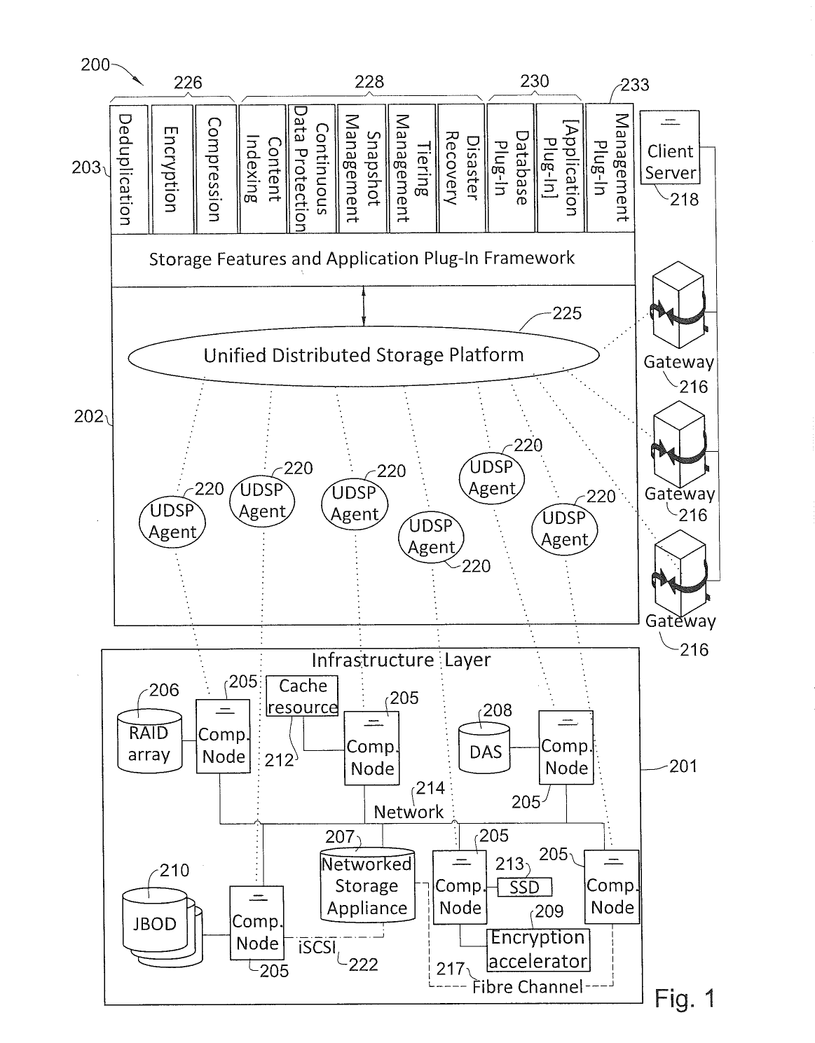

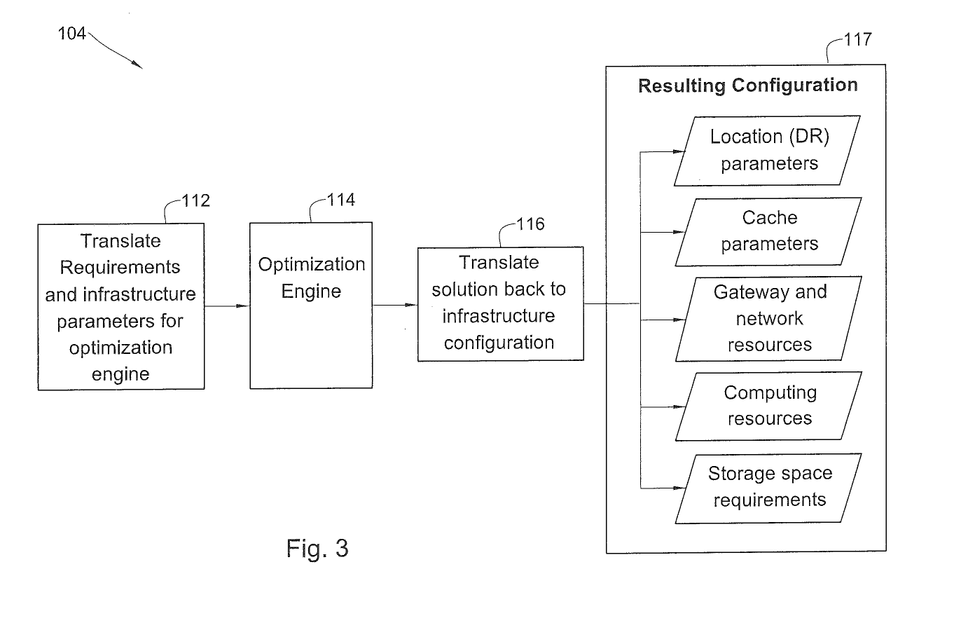

In embodiments of the presently disclosed subject matter, fewer, more and/or different stages than those shown in FIGS. 3, 4, 6-18 and 20-23 may be executed. In embodiments of the presently disclosed subject matter one or more stages illustrated in FIGS. 3, 4, 6-18 and 20-23 may be executed in a different order and/or one or more groups of stages may be executed simultaneously. FIGS. 1, 2, 5 and 19 illustrate a general schematic of the system architecture in accordance with an embodiment of the presently disclosed subject matter. Each module in FIGS. 1, 2, 5 and 19 can be made up of any combination of software, hardware and/or firmware that performs the functions as defined and explained herein. The modules in FIGS. 1, 2, 5 and 19 may be centralized in one location or dispersed over more than one location. In other embodiments of the presently disclosed subject matter, the system may comprise fewer, more, and/or different modules than those shown in FIGS. 1, 2, 5 and 19.

Bearing this in mind, attention is drawn to FIG. 1, which schematically illustrates a top-level architecture of a Distributed Storage System including an Infrastructure Layer, according to the presently disclosed subject matter. According to examples of the presently disclosed subject matter, Distributed Storage System (DSS) 200 can comprise one or more of the following layers: an Infrastructure Layer 201, a Unified Distributed Storage Platform (UDSP) layer 202, and an API/framework layer 203.

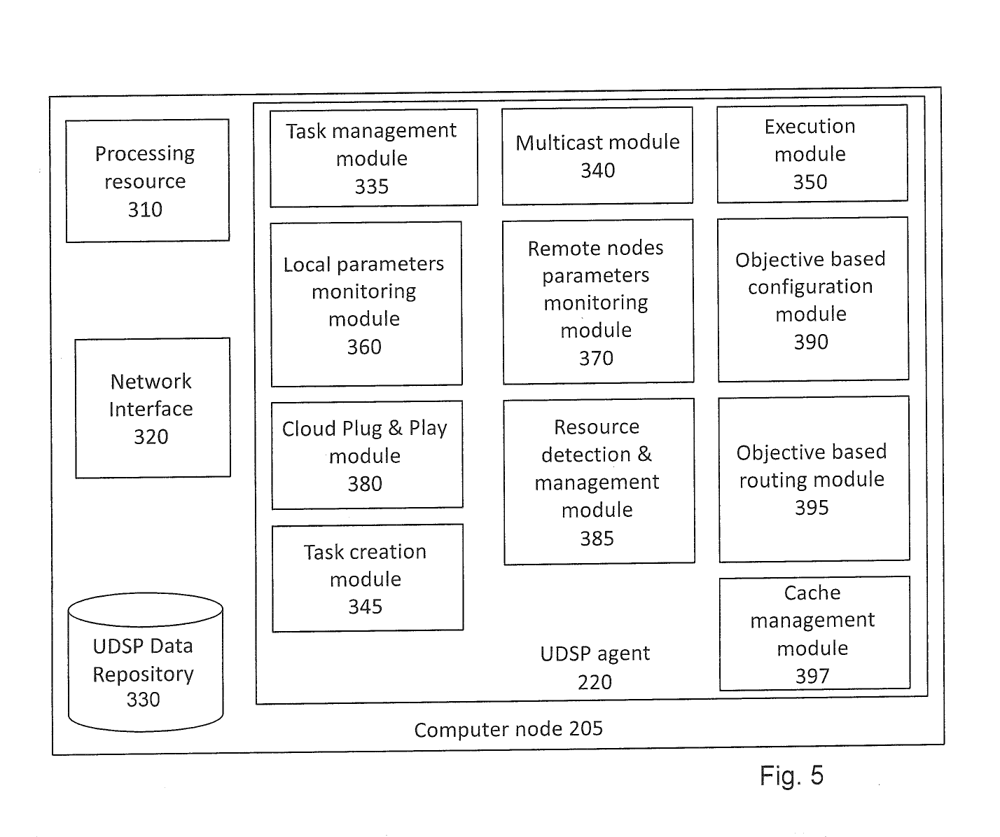

According to some examples of the presently disclosed subject matter, infrastructure layer 201 can include one or more interconnected computer nodes 205 (e.g. any type of computer including, inter alia, one or more processing resources such as one or more processing units, one or more memory resources such as a memory, and one or more network interfaces), and in some cases two or more interconnected computer nodes 205, on which a more detailed description is provided herein, inter alia with reference to FIG. 5. Infrastructure layer 201 can further include one or more of the following storage-related resources: (a) data storage resources (e.g. data storage device 204, RAID (redundant array of independent disks) 206, DAS (direct attached storage) 208, JBOD (just a bunch of drives) 210, network storage appliance 207 (e.g. SAN, NAS, etc.), SSD 213, etc.); (b) cache resources 212 such as memory resources (e.g. RAM, DRAM, etc.), volatile and/or non-volatile, and/or a data storage resources (e.g. SSD 213) that in some cases can be used additionally or alternatively as a cache resource), etc.; (c) network resources 214; and (d) additional resources providing further functionality to the DSS 200 and/or enhance its performance (such as compression accelerator, encryption accelerator 209, Host Bus adapter (HBA) enabling communication with SAN resources, etc.).

In some cases, the resources can include more than one of a same type of device, and/or more than one of a different type of device. A more detailed description of some of the resources will follow herein.

According to some examples of the presently disclosed subject matter, the computer nodes 205 can be interconnected by a network (e.g. a general-purpose network).

In some cases, one or more of the resources of the infrastructure layer 201 can be connected to one or more computer nodes 205 directly. In some cases, one or more of the resources of the infrastructure layer 201 can be comprised within a computer node 205 and form a part thereof. In some cases, one or more of the resources of the infrastructure layer 201 can be connected (e.g. by a logical connection such as iSCSI 222, etc.) to one or more of the computer nodes 205 by a network (e.g. a general-purpose network).

Optionally, the network can be a general-purpose network. Optionally, the network can include a WAN. Optionally, the WAN can be a global WAN such as, for example, the Internet. Optionally, the network resources can interconnect using an IP network infrastructure. Optionally, the network can be a Storage Area Network (SAN). Optionally, the network can include storage virtualization. Optionally, the network can include a LAN. Optionally, the network infrastructure can include Ethernet, Infiniband, FC (Fibre Channel) 217, FCoE (Fibre Channel over Ethernet), etc., or any combination of two or more network infrastructures. Optionally, the network can be any type of network known in the art, including a general purpose network and/or a storage network. Optionally, the network can be any network suitable for applying an objective-based management system for allocating and managing resources within the network, as further detailed herein. Optionally, the network can be a combination of any two or more network types (including, inter alia, the network types disclosed herein).

According to some examples of the presently disclosed subject matter, at least one resource of the infrastructure layer 201 (including, inter alia, the computer nodes 205, the data storage resources, the cache resources, the network resources, additional resources connected to a computer node 205, or any other resources) can be an off-the-shelf, commodity, not purposely-built resource connected to the network and/or to one or more computer nodes 205. It is to be noted that such a resource can be interconnected as detailed herein, irrespective of the resource characteristics such as, for example, manufacturer, size, computing power, capacity, etc. Thus, any resource (including, inter alia, the computer nodes 205), irrespective of its manufacturer, which can communicate with a computer node 205, can be connected to the infrastructure layer 201 and utilized by the DSS 200 as further detailed herein. In some cases any number of resources (including, inter alia, the computer nodes 205) can be connected to the network and/or to one or more computer nodes 205 and utilized by the DSS 200, thus enabling scalability of the DSS 200. In some cases, any number of computer nodes 205 can be connected to the network and any number of resources can be connected to one or more computer nodes 205 and utilized by the DSS 200, thus enabling scalability of the DSS 200. It is to be noted that a more detailed explanation about the process of connecting new resources (including, inter alia, the computer nodes 205) to the DSS 200 is further detailed herein, inter alia with respect to FIG. 5.

Turning to the UDSP layer 202, according to some examples of the presently disclosed subject matter, it can include one or more UDSP agents 220 that can be installed on (or otherwise associated with or comprised within) one or more of the computer nodes 205. In some cases, a UDSP agent 220 can be installed on (or otherwise associated with) each of the computer nodes 205. In some cases, a UDSP agent 220 can be additionally installed on (or otherwise associated with) one or more of gateway resources 216 (that can act, inter alia, as protocol converters as further detailed herein), and in some cases, on each of the gateway resources 216. In some cases, a UDSP agent 220 can be additionally installed on (or otherwise associated with) one or more of the client servers 218 (e.g. servers and/or other devices connected to the DSS 200 as clients), and in some cases, on each of the client servers 218. It is to be noted that in some cases, client servers 218 can interact with DSS 200 directly without a need for any gateway resources 216 that are optional. It is to be further noted that in some cases there can be a difference in the UDSP agent 220 (e.g. a difference in its functionality and/or its capability, etc.) according to its installation location or its association (e.g. there can be a difference between a UDSP agent 220 installed on, or otherwise associated with, a computer node 205, a UDSP agent 220 installed on, or otherwise associated with, a gateway resources 216, a UDSP agent 220 installed on, or otherwise associated with, a client server 218, etc.).

It is to be noted that a detailed description of the UDSP agents 220 is provided herein, inter alia with respect to FIG. 5. Having said that, it is to be noted that according to some examples of the presently disclosed subject matter, UDSP agents 220 can be configured to control and manage various operations of DSS 200 (including, inter alia, automatically allocating and managing the resources of the Infrastructure Layer 201, handling data-path operations, etc.). In some cases, UDSP agents 220 can be configured to manage a connection of a new computer node 205 to the Infrastructure Layer 201 of DSS 200. In some cases, UDSP agents 220 can be configured to detect resources connected to the computer node 205 on which they are installed and to manage such resources. As indicated above, a more detailed description of the UDSP agents 220 is provided herein, inter alia with respect to FIG. 5.

In some cases, UDSP layer 202 can include UDSP 225 which includes a management system for DSS 200. Optionally, management system processing can be implemented through one or more UDSP agents 220 installed on the computer nodes 205 in Infrastructure Layer 201, or through one or more UDSP agents 220 installed on a gateway resource 216 or on a client server 218 with access to DSS 200 (e.g. directly and/or through gateway resources 216), or any combination thereof.

Management system can enable a user to perform various management tasks (including, inter alia monitoring and reporting tasks) relating to DSS 200, such as, creating new logical storage entities (such as Logical Units, Object Stores, file system instances, etc.) that can be associated with Service Level Specifications (SLSs) (in some cases, each logical storage entity is associated with a single SLS), updating logical storage entities, granting access permissions of logical storage entities to gateway resources 216 and/or to client servers 218, creating snapshots, creating backups, failover to remote site, failback to primary site, monitoring dynamic behavior of DSS 200, monitoring SLSs compliance, generation of various (e.g. pre-defined and/or user-defined, etc.) reports (e.g. performance reports, resource availability reports, inventory reports, relationship reports indicative of relationships between computer nodes 205 and other resources, trend reports and forecast reports of various parameters including Key Performance Indicators, etc.) referring to different scopes of the DSS 200 (e.g. in the resolution of the entire DSS 200, certain sites, certain types of use such as for a certain SLS, certain resources, etc.), managing various alerts provided by DSS 200 (e.g. alerts of failed hardware, etc.), etc. It is to be noted that the above management tasks are provided as non-limiting examples only. It is to be noted that in some cases, the logical storage entities can be created automatically by DSS 200 according to the SLS, as further detailed herein. It is to be noted that each of the logical storage entities can be associated with one or more data storage resources.

It is to be noted that throughout the specification, when reference is made to a user, this can refer to a human operator such as a system administrator, or to any type of auxiliary entity. An auxiliary entity can refer for example to an external application such as an external management system, including an auxiliary entity that does not require any human intervention, etc.

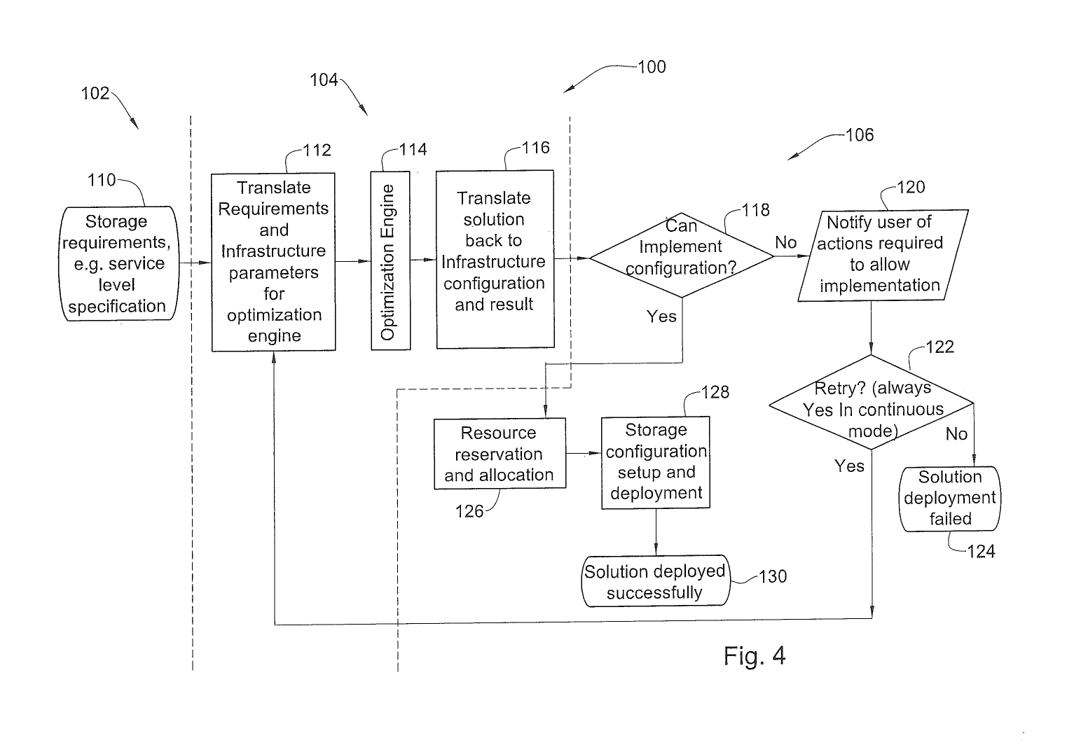

In some cases, management system can enable a user to provide DSS 200 with user-defined storage requirements defining a service level specification (SLS) specifying various requirements that the user requires the DSS 200 to meet. In some cases, the SLS can be associated with a logical storage entity. Optionally, the SLS can include information such as, for example, specifications of one or more geographical locations where the data is to be stored and/or handled; a local protection level defining availability, retention, DR requirements (such as Recovery Point Objective—RPO, Recovery Time Objective—RTO, required global and/or local redundancy level, a remote protection level for DR defining one or more remote geographical locations in order to achieve specified availability, retention and recovery goals under various disaster scenarios, etc., as further detailed inter alia with reference to FIG. 4); a backup retention policy defining for how long information should be retained; local and/or remote replication policy; performance levels (optionally committed) defined using metrics such as IOPS (input/output operations per second), response time, and throughput; encryption requirements; de-duplication requirements; compression requirements; a storage method (physical capacity, thin capacity/provisioning), etc.

In some cases, management system can enable management (including creation, update and deletion) of various Service Level Groups (SLGs). An SLG is a template SLS that can be shared among multiple logical storage entities. An SLG can be a partial SLS (that requires augmentation) and/or contain settings that can be overridden. Thus, for example, an SLG can define various recovery parameters only that can be inherited by various SLSs, each of which can add and/or override SLS parameters.

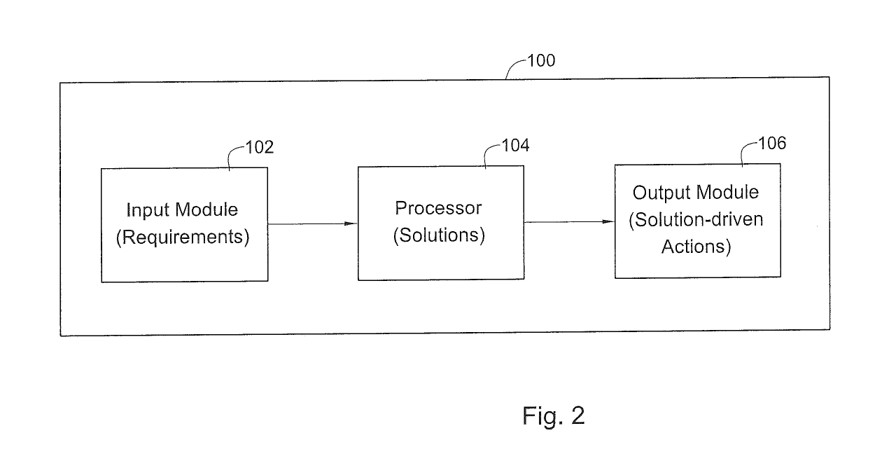

According to some examples of the presently disclosed subject matter, UDSP 225 can include an automatic management system for allocating resources and managing the resources in the DSS 200. Optionally, the automatic management system is an Objective-Based Management System (OBMS) 100 that can be configured to allocate and manage the resources in the network, inter alia based on any one of, or any combination of, user-defined requirements defined by one or more service level specifications (SLSs), data of various parameters relating to computer nodes 205 and/or to resources connected thereto, data of various parameters that refer to the DSS 200 or parts thereof (e.g. maximal allowed site-level over-commit, maximal allowed overall over-commit, various security parameters, etc.) and data of various parameters that refer to the dynamic behavior of the DSS 200 and the environment (e.g. the client servers 218, gateway resources 216, etc.), as further detailed herein, inter alia with respect to FIG. 2 and FIG. 5. Optionally, OBMS 100 processing can be implemented through one or more UDSP agents 220 installed on one or more of the computer nodes 205 in Infrastructure Layer 201, or through one or more UDSP agents 220 installed on a gateway resource 216 or on a client server 218 with access to DSS 200 (e.g. directly or through gateway resources 216), or any combination thereof.

According to some examples of the presently disclosed subject matter, API/framework layer 203 includes a plug-in layer which facilitates addition of software extensions (plug-ins) to DSS 200. Such plug-ins can be utilized for example for applying processes to the data, introducing new functionality and features to DSS 200, interfacing DSS 200 with specific applications and implementing application-specific tasks (e.g. storage related tasks, etc.), implementing various resource specific drivers, introducing new SLS parameters and/or parameter group/s (e.g. in relation to a plug-in functionality and/or goals), implementing management functionality, etc. In some cases, the plug-in layer can also include drivers associated with various hardware components (e.g. encryption cards, etc.).

In some cases the plug-ins can be deployed on one or more UDSP agents 220. In some cases, the plug-ins can be deployed on one or more UDSP agents 220 for example, according to the plug-in specifications (e.g. a software encryption plug-in can be installed on any UDSP agent 220), according to various resources connected to a computer node 205 and/or to a gateway resource 216 and/or to a client server 218 on which a UDSP agent 220 is installed (e.g. a hardware accelerator plug-in can be automatically deployed on each UDSP agent 220 associated with a computer node 205 that is associated with such a hardware accelerator), according to a decision of the automatic management system (e.g. OBMS 100), or according to a selection of a system administrator, etc. In some cases the plug-ins can be deployed automatically, e.g. by the automatic management system (e.g. OBMS 100) and/or by the computer nodes 205. Optionally, the software extensions can include data processing plug-ins 226 such as, for example, a data deduplication plug-in enabling for example deduplication of data stored on DSS 200, a data encryption plug-in enabling for example encryption/decryption of data stored on DSS 200, a data compression plug-in enabling for example compression/decompression of data stored on DSS 200, etc. Optionally, the software extensions can include storage feature plug-ins 228 such as, for example, a content indexing plug-in enabling for example indexing of data stored on DSS 200, a snapshot management plug-in enabling management of snapshots of data stored on DSS 200, a tiering management plug-in enabling for example tiering of data stored on DSS 200, a disaster recovery plug-in enabling for example management of process, policies and procedures related to disaster recovery, a continuous data protection plug-in enabling for example management of continuous or real time backup of data stored on DSS 200, etc. Optionally, the software extensions can include application plug-ins 230 such as, for example a database plug-in enabling for example accelerating query processing, a management plug-in 233 enabling for example performance of various DSS 200 management tasks and other interactions with users, client servers 218, and other entities connected to DSS 200, and other suitable application plug-ins.

As indicated herein, in some cases, a plug-in can introduce new SLS parameters and/or parameter group(s) (e.g. in relation to a plug-in functionality and/or goals). In such cases, according to the plug-in functionality, respective SLS parameters and/or parameter group(s) can be introduced to DSS 200. Such introduced SLS parameters can be used in order to set plug-in related requirements, e.g. by a user and/or automatically by the automatic management system (e.g. OBMS 100), etc.

In some cases, the software extensions can be stored on one of the computer nodes 205 or distributed on more than one computer node 205. In some cases, the software extensions can be stored on one or more data storage resources connected to one or more computer nodes 205. In some cases, the software extensions can be stored in a virtual software extensions library that can be shared by the UDSP agents 220.

In some cases, the software extensions can be managed, automatically and/or manually (e.g. by a system administrator). Such management can sometimes be performed by utilizing the management plug-in 233. In such cases, management plug-in 233 can enable addition/removal of software extension to/from DSS 200, addition/removal of various software extensions to/from one or more UDSP agents 220, etc.

Following the description of the top-level architecture of DSS 200, a detailed description of a DSS 200 configuration process that can be performed by Objective Based Management System (OBMS) 100 is hereby provided. For this purpose, attention is now drawn to FIG. 2, illustrating a simplified, exemplary system for configuring a Distributed Storage System 200, according to the presently disclosed subject matter. For this purpose, OBMS 100 can be configured, inter alia, to automatically allocate and manage resources in the Infrastructure Layer 201. OBMS 100 can include an Input Module 102, one or more Processors 104, and an Output Module 106.

In some cases, input Module 102 can be configured to receive input data. Such input data can include, inter alia, any one of, or any combination of, user-defined storage requirements defined by one or more service level specifications (SLSs), definitions of one or more logical storage entities, data of various parameters relating to computer nodes 205 and/or to resources connected thereto (including storage-related resources, also referred to as storage-related resources data), data of various parameters that refer to the DSS 200 or parts thereof (e.g. maximal allowed site-level over-commit, maximal allowed overall over-commit, various security parameters, etc.), data of various parameters relating to dynamic behavior (dynamic behavior parameter data) of the DSS 200 and the environment (e.g. the client servers 218, gateway resources 216, etc.), etc.

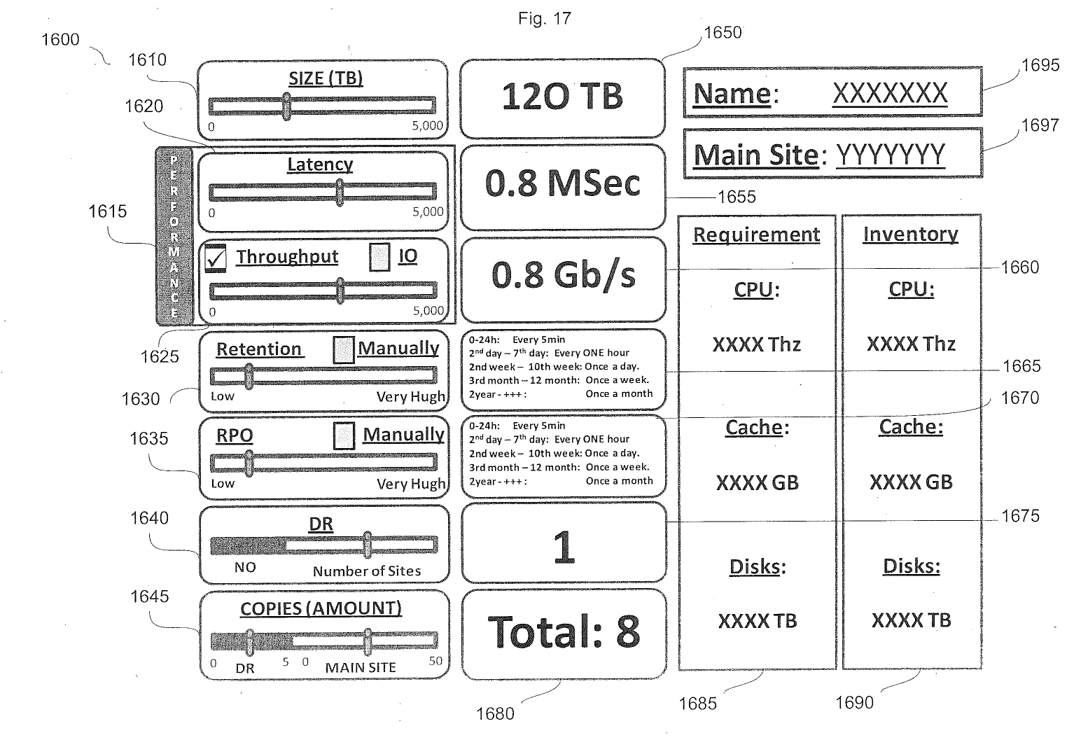

In some cases, user-defined requirements can define one or more service level specifications (SLSs) specifying various requirements that one or more users require the DSS 200 and/or one or more logical storage entities to meet. It is to be noted that such requirements can be received from a human operator (e.g. a system administrator, etc.), for example, through a user interface, as further detailed herein, inter alia with respect to FIGS. 16 and 17.

In some cases, the data of various parameters relating to dynamic behavior of the DSS 200 and the environment (dynamic behavior parameter data) can include various parameters data indicative of the current state of one or more of the DSS 200 components (including the computer nodes 205 and the resources connected thereto). Such data can include data of presence and/or loads and/or availability and/or faults and/or capabilities and/or response time(s) and/or connectivity and/or cost(s) (e.g. costs of network links, different types of data storage resources) and/or any other data relating to one or more of the resources, including data relating to one or more computer nodes 205, one or more gateway resources 216, one or more client servers 218, etc. In some cases, such data can include, inter alia, various statistical data.

In some cases, the data of various parameters relating to computer nodes 205 and/or to resources connected thereto (including storage-related resources, also referred to as storage-related resources data) can include data of various parameters indicative of the resources of the DSS 200, including hardware resources, including storage-related resources, such as, for example:

a. parameters relating to a data storage resource, (e.g. for each of the its hard drives):
1. Hard drive category parameters (e.g. hard drive size, interface (e.g. SAS, SATA, FC, Ultra-SCSI, etc.), cache size, special features (e.g. on-drive encryption, etc.), etc.);
2. Hard drive performance parameters (e.g. response time, average latency, random seek time, data transfer rate, etc.);
3. Hard drive power consumption;
4. Hard drive reliability parameters (e.g. Mean Time Between Failure (MTBF), Annual Failure Rate (AFR), etc.).

b. computer node 205 parameters:
1. Number of CPUs and cores per CPU.
2. Performance parameters of each CPU and/or core, such as frequency, L2 and L3 cache sizes.
3. Architecture (e.g. does the CPU and/or core support 64-bit computing, is it little-endian or big-endian)
4. Support for certain instruction sets (e.g. AES-NI, a new instruction set for speeding up AES encryption).
5. Number of hard drive slots available;
6. Available storage interfaces (SATA, SAS, etc.);
7. Maximal amount of memory;
8. Supported memory configurations;

c. Cache resource parameters:
1. Cache resource type (e.g. DRAM, SSD), size and performance.
2. Is the cached storage space local or remote.
3. NUMA parameters.

d. Gateway resource parameters:
1. Number of CPUs and cores per CPU.
2. Performance parameters of each CPU and/or core, such as frequency, L2 and L3 cache sizes.
3. Architecture (e.g. does the CPU and/or core support 64-bit computing, is it little-endian or big-endian)
4. Support for certain instruction sets (e.g. AES-NI, a new instruction set for speeding up AES encryption).
5. Number of hard drive slots available in the enclosure;
6. Available storage interfaces (SATA, SAS, etc.);
7. Maximal amount of memory;
8. Supported memory configurations;
9. Networking parameters relating to gateway (number of ports, speed and type of each port, etc.)

e. Network resource parameters:
1. Switching and routing capacities;
2. Network types;
3. Security parameters.

It is to be noted that these are mere examples and additional and/or alternative various parameters can be used.

In some cases, data relating to dynamic behavior of the DSS 200 and the environment (dynamic behavior parameter data) can include various parameters indicative of the resources of the DSS 200, including hardware resources such as, for example:

a. Parameters relating to a data storage resource (e.g. for each of its hard drives):
1. Hard drive free space.
2. S.M.A.R.T. parameters of the hard drive.
3. The power state of the hard drive (turned off, in spin-up phase, ready, etc.)
4. Recent and current load on hard drive.
5. Existing allocations and reservations.

b. Computer node 205 parameters:
1. Recent and current load statistics for each core.
2. Existing allocations and reservations.
3. Current amount of memory.

c. Cache resource parameters:
1. Available size.
2. Occupancy level of the cache.
3. Recent and current swapping/page fault statistics.
4. Existing allocations and reservations.

d. Gateway resource parameters:
1. Recent and current network connections statistics.
2. Recent and current node load statistics.
3. Recent and current latency statistics.
4. Recent and current routing cost statistics (for commands routed by a gateway into a DSS).
5. Existing allocations and reservations.

e. Network resource parameters:
1. Recent and current load of network segments.
2. Recent and current reliability and quality parameters of network segments.
3. Existing allocations and reservations.

It is to be noted that these are mere examples and additional and/or alternative various parameters can be used.

In some cases, input Module 102 can be configured to transfer the input data to one or more Processors 104. As indicated, OBMS 100 processing can be implemented through one or more UDSP agents 220 (e.g. while utilizing Objective based configuration module 380 as further detailed herein, inter alia with reference to FIG. 5), e.g. through UDSP agents 220 installed on one or more of the computer nodes 205 in Infrastructure Layer 201, or through UDSP agents 220 installed on one or more gateway resources 216, or through UDSP agents 220 installed on one or more client servers 218 with access to DSS 200 (e.g. directly or through gateway resources 216), or any combination thereof. In such cases, the one or more processors 104 can be one or more processing resources (e.g. processing units) associated with such UDSP agents 220 (e.g. if the processing is implemented through a UDSP agent 220 installed on a computer node 205, then processor can be the processing unit of that computer node 205, etc.). It is to be noted that more than one processing resource (e.g. processing unit) can be used for example in case of parallel and/or distributed processing.

The one or more Processors 104 can be configured to receive the input data from Input Module 102 and to perform an optimization process based on the input data for determining configuration requirements that meet all of the user-defined storage requirements (e.g. SLSs) provided by the one or more users of DSS 200, inter alia with respect to entities that they affect (such as logical storage entities associated with such SLSs). A more detailed description of the optimization process and of the determined configuration requirements is provided herein, inter alia with respect to FIG. 3.

The configuration requirements can be transferred to Output Module 106 which, in some cases, can determine if the current DSS 200 resources are sufficient to meet the determined configuration requirements. Accordingly, Output Module 106 can be configured to perform solution-driven actions, which include allocation, reservation, commit or over-commit (e.g. virtually allocating more resources than the actual resources available in the infrastructure layer 201) of the resources if the configuration requirements can be met by the system, or issuing improvement recommendations to be acted upon by the user which may include adding resources and/or adding plug-ins and/or any other recommendations for enabling the system to meet the configuration requirements. Such improvement recommendations can include, for example, recommendation to add one or more resources, to add or upgrade one or more plug-ins, to span the infrastructure across additional and/or different locations (local and/or remote), etc.

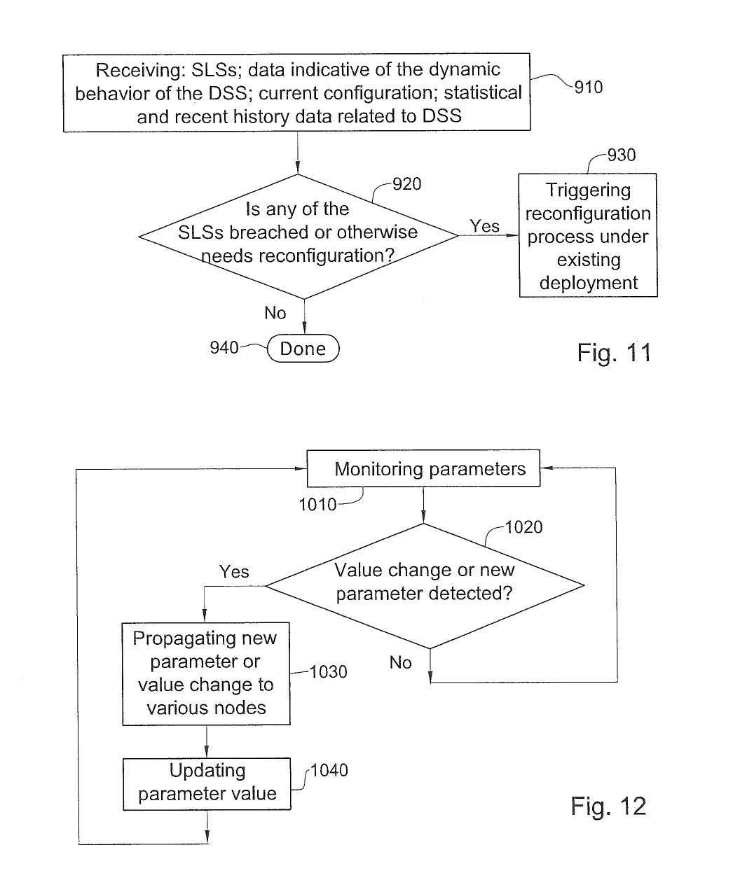

It is to be noted that in some cases the configuration process, or parts thereof, can be initiated when deploying the DSS 200 and/or one or more logical storage entities for the first time, and/or following one or more changes (e.g. pre-defined changes) applied to DSS 200 and/or to one or more logical storage entities (e.g. addition/removal of a resource such as computer nodes 205, cache resources, data storage resources, network resources, plug-ins or any other resource to DSS 200; a change in one or more user-defined storage requirements; etc.), and/or according to the dynamic behavior of DSS 200 (as further detailed below, inter alia with respect to FIG. 5 and FIG. 11), etc. Additionally or alternatively, the configuration process, or parts thereof, can be initiated in a semi-continuous manner (e.g. at pre-determined time intervals, etc.). Additionally or alternatively, the configuration process, or parts thereof, can be performed continuously.

It is to be further noted that, with reference to FIG. 2, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to system elements that realizes them, this is by no means binding, and the blocks can be performed by elements other than those described herein.

Attention is now drawn to FIG. 3, which schematically illustrates a simplified and exemplary flow diagram of an optimization process performed by the objective-based storage management system, according to the presently disclosed subject matter. In some cases, one or more Processors 104 can be configured to receive input data (e.g. from input module 102) and, in some cases, convert the received input data into a format suitable for processing by an optimization engine (e.g. into an optimization problem representation) (block 112).

An optimization engine associated with one or more Processors 104 can be configured to perform an optimization process, based on the original and/or converted input data to arrive at a required configuration which satisfies the requirements as defined by the input data (as further detailed herein, inter alia with respect to FIG. 2) (block 114). It is to be noted that in some cases, the optimization process can be instructed to return the first valid solution that it finds, whereas in other cases, the optimization process can be instructed to search for the optimal solution out of a set of calculated valid solutions. Optionally, the optimization techniques used in the optimization process can include any one of, or any combination of, linear programming, simulated annealing, genetic algorithms, or any other suitable optimization technique known in the art. Optionally, the optimization technique can utilize heuristics and/or approximations. Optionally, optimization decisions can be taken based on partial and/or not up-to-date information.

In some cases, the output of the optimization engine can be converted by the one or more Processors 104 from an optimization solution representation to a configuration requirements representation (block 116).

In some cases, the configuration requirements are output by the one or more Processors 104 for example as any one of, or any combination of, the following: location requirements (e.g. availability of at least one additional site, availability of a certain amount of storage space in the additional site/s, maximal latency between sites, minimal geographical distance between sites for example for disaster recovery purposes, etc.), cache resources requirements (e.g. required cache size, required cache type, required cache locations, required cache performance parameters, etc.), gateway resources requirements (e.g. required Fibre Channel bandwidth, required processing performance parameters, etc.), network resources requirements (e.g. required network bandwidth, required network type, etc.), computing resources requirements (e.g. computer nodes processing performance parameters, computer nodes number of CPU cores, etc.), data storage resources requirements (e.g. required storage space, required storage type, etc.), additional resource requirements (e.g. required compression performance, required encryption performance, etc.), plug-in requirements (e.g. required database plug-in, etc.), environment requirements (e.g. required physical security level, etc.), etc. (block 117).

It is to be noted that, with reference to FIG. 3, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Turning to FIG. 4, there is shown a schematic illustration of a simplified flow diagram of an exemplary operational algorithm of a configuration process performed by the objective-based management system, according to the presently disclosed subject matter. In some cases, as indicated above, Input Module 102 can receive the input data and transfer the data to the one or more Processors 104 (block 110). As further indicated above, the one or more Processors 104 can, in some cases, convert the input data into a format suitable for processing by an optimization engine (e.g. into an optimization problem representation) (block 112).

An optimization engine associated with one or more Processors 104 can be configured to perform an optimization process, based on the original and/or converted input data to arrive at a required configuration which satisfies the requirements as defined by the input data (as further detailed herein, inter alia with respect to FIG. 2) (block 114). In some cases, the output of the optimization engine can be converted by the one or more Processors 104 from an optimization solution representation to a configuration requirements representation (block 116).

In some cases, output module can compare the required configuration with the actual data of the DSS 200 resources (e.g. the computer nodes 205, the storage-related resources, etc.) and/or environment for determination if the DSS 200 can meet the required configuration (block 118). It is to be noted that in some cases the actual DSS 200 resources can refer to those parts of the DSS 200 resources that are currently available. If the actual DSS 200 resources and/or environment can meet the required configuration, OBMS 100 can be configured to reserve and/or allocate the resources according to the required configuration (block 126). In some cases, OBMS 100 can be configured to set up the DSS 200 configuration and/or perform any induced deployment actions (block 128). In some cases, the set-up and/or deployment action can include, inter alia, automatically creating new logical storage entities (such as Logical Units, Object Stores, file system instances, etc.) associated with SLSs. In some cases, each logical storage entity is associated with a single SLS.

As part of setting-up the storage configuration and/or performing any induced deployment actions, relevant set-up and/or deployment action requests can be sent to the UDSP agents 205; in some cases such requests are sent to the UDSP agents 205 associated with the storage-related resources relevant for the requested set-up and/or deployment action. In some cases, the UDSP agents 205 that receive such requests can be configured to update a data repository associated therewith about the set-up and/or deployment requested to be used by DSS 200 as further detailed below, inter alia with respect to FIG. 5. In some cases, following the deployment, the process of deploying the DSS 200 ends successfully (block 130).

If the actual DSS 200 resources and/or environment cannot meet the required configuration, OBMS 100 can be configured to send a message to the user (e.g. a system administrator) providing the user with a failure notification and/or recommendations as to corrective actions to be taken by the user for allowing implementation of the required infrastructure configuration (block 120). Optionally, the action can include adding infrastructure resources which will allow successful calculation of a configuration. Optionally, the action can include adding relevant plug-ins. Optionally, the action can involve spanning infrastructure resources across additional and/or alternative locations. It is to be noted that the recommendations disclosed herein are mere examples, and other recommendations can be additionally or alternatively issued to the user. In some cases, OBMS 100 can be configured to make a decision as to whether the required infrastructure configuration should be re-evaluated, optionally after some interval/delay, or not (block 122). If yes, OBMS 100 can be configured to return to block 112. Optionally, the Output Module 106 automatically goes to 112, optionally after some interval/delay, if set to a continuous mode. Optionally, the decision to retry or not is based on user input of a retry instruction. If no, the process of deploying the DSS 200 failed. In some cases, OBMS 100 can be configured to report failures.

It is to be noted that, with reference to FIG. 4, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 5, in which a block diagram schematically illustrating an exemplary computer node connected to the Distributed Storage System, according to certain examples of the presently disclosed subject matter, is shown.

According to some examples of the presently disclosed subject matter, Computer node 205 can comprise one or more processing resources 310. The one or more processing resources 310 can be a processing unit, a microprocessor, a microcontroller or any other computing device or module, including multiple and/or parallel and/or distributed processing units, which are adapted to independently or cooperatively process data for controlling relevant computer node 205 resources and/or storage-related resources connected to computer node 205 and for enabling operations related to computer node 205 resources and/or to storage-related resources connected to computer node 205.

Computer node 205 can further comprise one or more network interfaces 320 (e.g. a network interface card, or any other suitable device) for enabling computer node 205 to communicate, inter alia with other computer nodes and/or other resources connected to DSS 200.

According to some examples of the presently disclosed subject matter, computer node 205 can be associated with a UDSP data repository 330, configured to store data, including inter alia data of various user-defined storage requirements defining SLSs, and/or data of a logical storage entities associated with each SLS, and/or data of various parameters relating to computer nodes 205 and/or to storage-related resources connected thereto and/or data relating to various parameters that refer to the DSS 200 or parts thereof and/or data relating to dynamic behavior of the DSS 200 and the environment (e.g. the client servers 218, gateway resources 216, etc.), and/or data relating to the DSS 200 set-up and/or deployment and/or any other data. In some cases, UDSP data repository 330 can be further configured to enable retrieval, update and deletion of the stored data. It is to be noted that in some cases, UDSP data repository 330 can be located locally on computer node 205, on a storage-related resource connected to computer node 205 (e.g. a data storage resource, a cache resource, or any other suitable resource), on a client server 218, on a gateway resource 216, or any other suitable location. In some cases, UDSP data repository 330 can be distributed between two or more locations. In some cases, UDSP data repository 330 can be additionally or alternatively stored on one or more logical storage entities within the DSS 200. In some cases, additionally or alternatively, UDSP data repository 330 can be shared between multiple computer nodes.

According to some examples of the presently disclosed subject matter, computer node 205 can further comprise a UDSP agent 220 that can be executed, for example, by the one or more processing resources 310. As indicated above, UDSP agents 220 can be configured, inter alia, to control and manage various operations of computer node 205 and/or DSS 200. UDSP agent 220 can comprise one or more of the following modules: a task management module 335, a multicast module 340, a task creation module 345, an execution module 350, a local parameters monitoring module 360, a remote nodes parameters monitoring module 370, a cloud plug & play module 380, a resource detection and management module 385, a User Interface (UI) module 387, an objective based configuration module 390, a cache management module 397 and an objective based routing module 395.

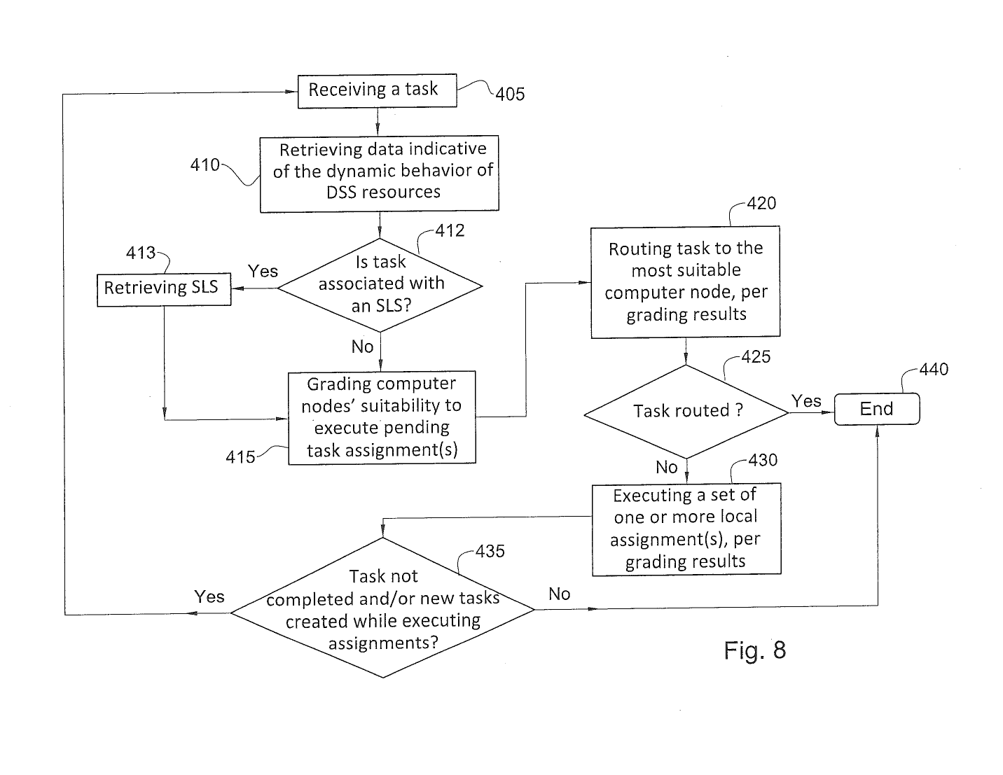

According to some examples of the presently disclosed subject matter, task management module 335 can be configured to manage a received task, such as a data path operation (e.g. read/write operation), as further detailed, inter alia with respect to FIG. 8.

Multicast module 340 can be configured to propagate (e.g. by unicast/multicast/recast transmission) various notifications to various UDSP agents 220 (e.g. UDSP agents installed on other computer nodes, gateway resources 216, client servers 218, etc.). Such notifications can include, for example, notifications of a resource status change, notifications of addition of a new resource, notifications of disconnection of a resource, notifications of a change in a local parameter, etc. In addition, multicast module 340 can be configured to handle any protocols between various UDSP agents 220 and other entities of the DSS 200 as well as external entities (such as external management systems, etc.).

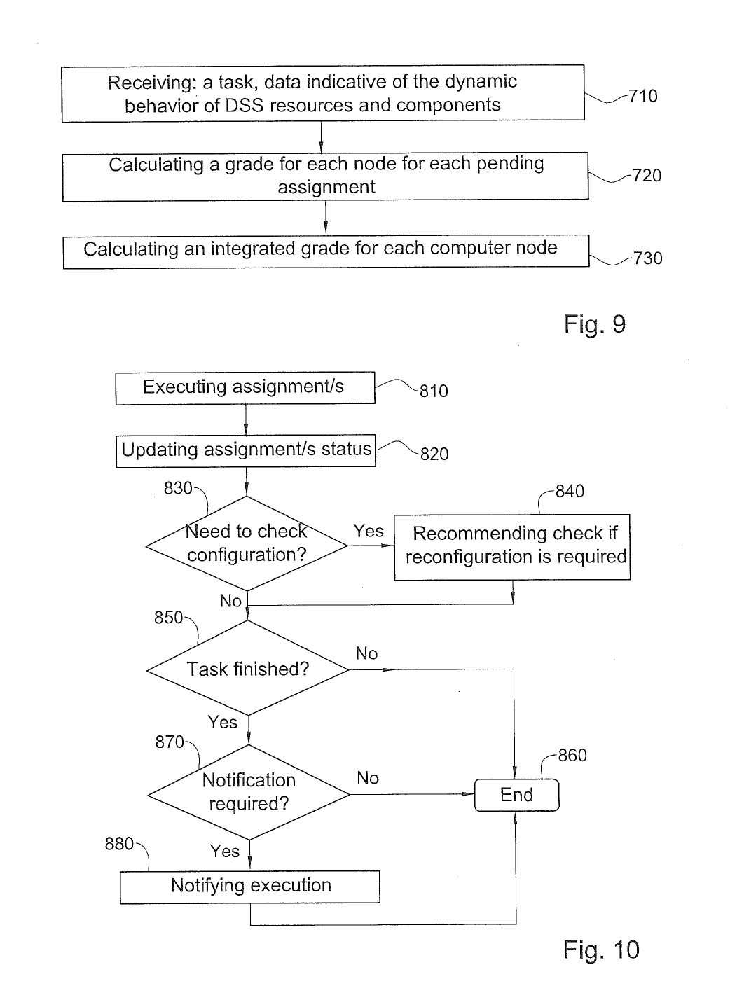

Task creation module 345 can be configured to create a new task for execution in DSS 200, as further detailed inter alia with respect to FIGS. 8 and 9.

Execution module 350 can be configured to locally execute one or more assignments associated with a received task, as further detailed herein, inter alia with respect to FIG. 10.

Local parameters monitoring module 360 can be configured to monitor various local parameters, such as parameters indicative of the dynamic behavior of the computer node 205 and/or any resource connected thereto, and propagate (e.g. while utilizing Multicast module 340) notifications indicative of a change to one or more local parameters, as further detailed, inter alia with respect to FIG. 12. It is to be noted that in some cases local parameters are parameters relating to a specific computer node 205 (or a gateway resource 216 or a client server 218, mutatis mutandis), on which the monitoring is performed, and/or to resources connected thereto.

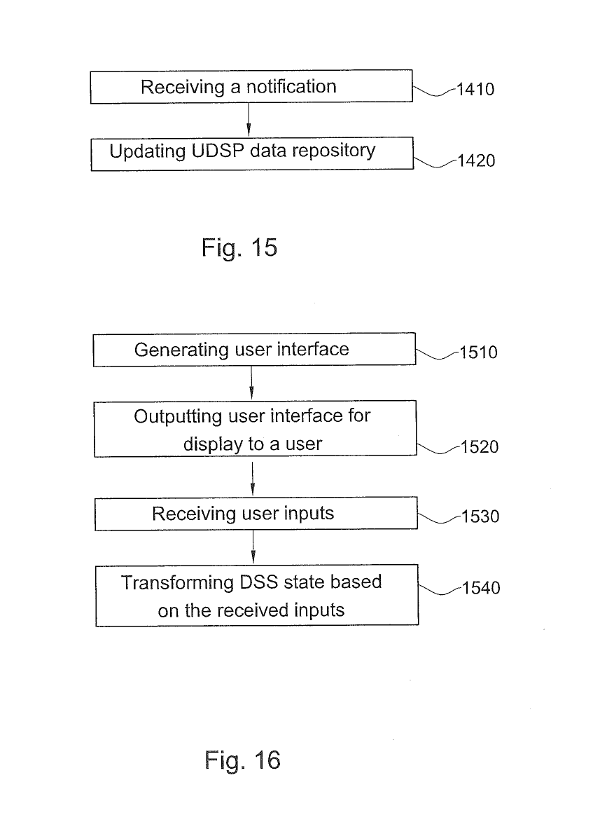

Remote nodes parameters monitoring module 370 can be configured to receive notifications indicative of a change in one or more parameters of one or more remote computer nodes 205 and/or resources connected thereto, and update UDSP data repository 330 accordingly, as further detailed, inter alia with respect to FIG. 15. In some cases, remote nodes parameters monitoring module 370 can be configured to register with another computer node 205 (e.g. with a UDSP agent 220 associated with the other computer node 205) to receive selective notifications therefrom. It is to be noted that in some cases, remote nodes parameters monitoring module 370 can be configured to independently and/or actively query a remote computer node 205 for any required information.

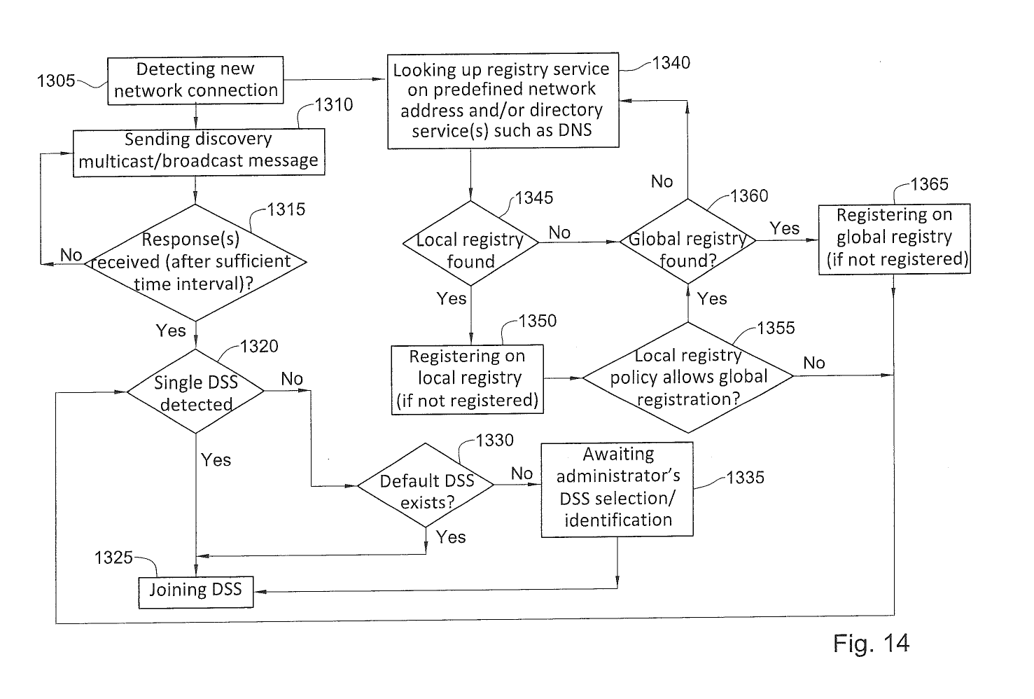

Cloud plug & play module 380 can be configured to enable autonomous and/or automatic connection of a computer node 205 to DSS 200, as further detailed, inter alia with respect to FIG. 14.

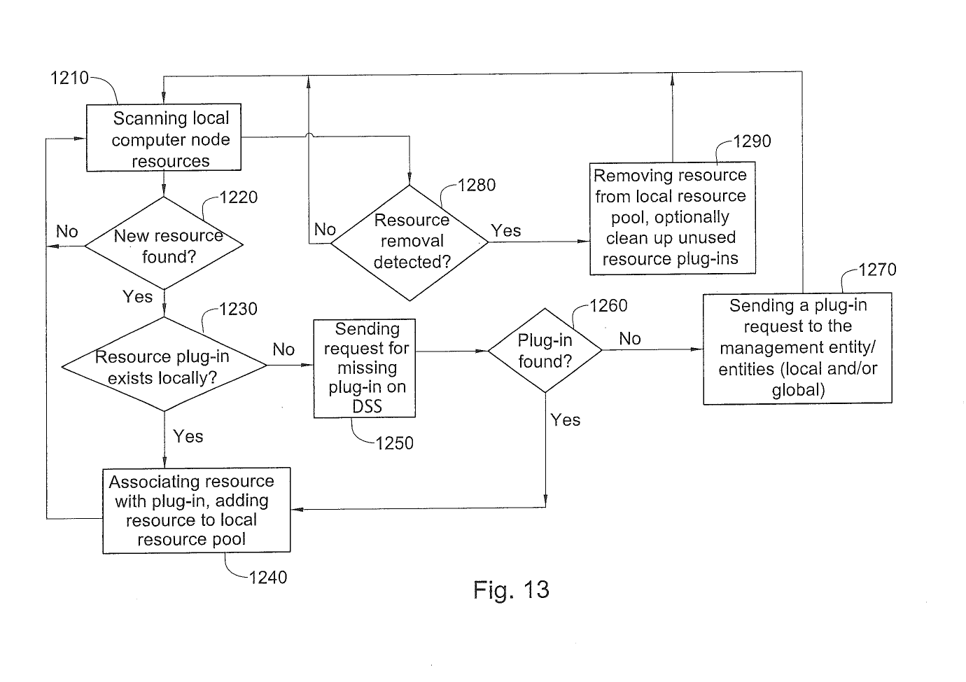

Resource detection and management module 385 can be configured to detect and manage resources connected to the computer node 205, as further detailed inter alia with respect to FIG. 13.

UI module 387 can be configured to generate a user interface enabling a user to provide input defining various SLS requirements, as detailed inter alia with respect to FIGS. 16 and 17.

Objective based configuration module 390 can be configured to configure and/or reconfigure DSS 200 as detailed inter alia with respect to FIGS. 2-4 and 11.

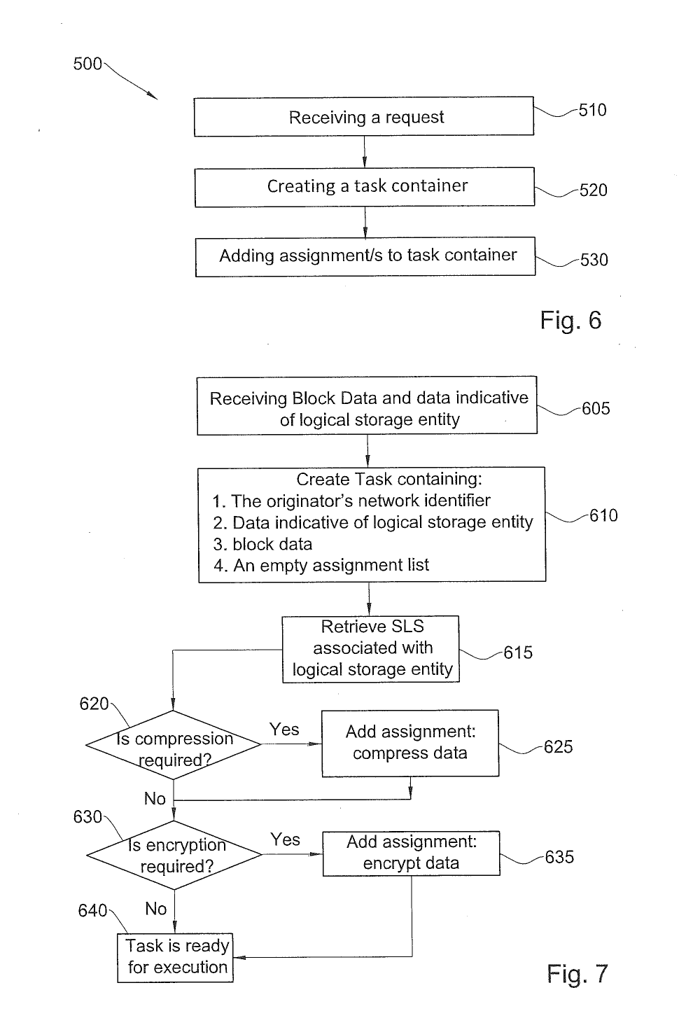

Objective based routing module 395 can be configured to route a received task to a computer node 205 as further detailed, inter alia with respect to FIGS. 6 and 8.

Cache management module 397 can be configured, inter alia, to monitor parameters relating to cache resources, and to manage cache resources connected to the computer node (including, inter alia, to perform cache handoffs), as further detailed herein, inter alia with respect to FIGS. 16-22.

It is to be noted that the one or more processing resources 310 can be configured to execute the UDSP agent 220 and any of the modules comprised therein.

It is to be noted that according to some examples of the presently disclosed subject matter, some or all of the UDSP agent 220 modules can be combined and provided as a single module, or, by way of example, at least one of them can be realized in a form of two or more modules. It is to be further noted that in some cases UDSP agents 220 can be additionally or alternatively installed on one or more gateway resources 216 and/or client servers 218, etc. In such cases, partial or modified versions of UDSP agents 220 can be installed on and/or used by the one or more gateway resource 216 and/or client server 218, etc.

Turning to FIG. 6, there is shown a flowchart illustrating a sequence of operations carried out for creating a task, according to certain examples of the presently disclosed subject matter. A task can be generated in order to execute a requested operation received by the DSS 200 (e.g. a read/write operation, a management operation, etc.). In some cases, a task can comprise a list of one or more assignments to be executed as part of the requested operation.

In some cases, task creation module 345 can perform a task creation process 500. For this purpose, in some cases, task creation module 345 can receive a requested operation (block 510) originating for example from a client server 218, a gateway resource 216, a computer node 205, or any other source. The received requested operation can include data indicative of the type of operation (e.g. read, write, management, etc.), and/or any other data relevant to the requested operation (e.g. in a write request, data indicative of the relevant logical storage entity on which the operation is to be performed, a block to be written, etc.).

Task creation module 345 can be configured to create a task container (block 520). The task container can comprise, inter alia, one or more of: data indicative of the requested operation originator (e.g. a network identifier thereof), data indicative of the relevant logical storage entity on which the operation is to be performed, operation specific data (e.g. in case of a block-write operation—the block to write) and an empty assignment list.

In some cases, e.g. when the request is associated with a logical storage entity, task creation module 345 can be configured to retrieve the SLS associated with the logical storage entity, and create one or more assignments to be performed in accordance with the SLS (for example, if the SLS requires data to be encrypted, an encryption assignment can be automatically created, etc.) (block 530).

It is to be noted that the task creation process 500 can be performed by task creation module 345 of UDSP agent 220 associated with computer node 205. However, it is to be noted that additionally and/or alternatively, task creation process 500 can be performed by task creation module 345 of UDSP agent 220 associated with client server 218 and/or gateway resource 216, or any other source having a task creation module 345. Thus, in some cases, computer node 205 can receive one or more tasks that have already been created, e.g. by a client server 218 and/or a gateway resource 216, etc.

It is to be noted that, with reference to FIG. 6, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

In order to better understand the process of a task creation, attention is drawn to FIG. 7, showing a flowchart illustrating a sequence of operations carried out for creating an exemplary storage block-write task, according to certain examples of the presently disclosed subject matter. In the example provided herein, task creation module 345 can receive block data to be written in DSS 200 and data indicative of the relevant logical storage entity on which the block is to be written (block 605).

In some cases, task creation module 345 can be configured to create a new task container. The task container can comprise, inter alia, data indicative of the originator from which the operation originated (e.g. a network identifier thereof), data indicative of the relevant logical storage entity on which the block is to be written, storage block data to be written in the logical storage entity and an empty assignment list (block 610).

In some cases, each task can be assigned with a Generation Number. Such a Generation Number can be a unique sequential (or any other ordered value) identifier that can be used by various plug-ins and resources in order to resolve conflicts and handle out-of-order scenarios. For example, it can be assumed that a first task (FT) is issued before a second conflicting task (ST) and that the ST is received for processing first. In such cases, the execution module 350 can be configured to check if the Generation Number of FT is earlier than that of ST, and in such cases, execution module 350 can be configured not to overwrite the data previously updated according to ST.

Task creation module 345 can also be configured to retrieve the SLS associated with the logical storage entity on which the operation is to be performed (block 615), and introduce relevant assignments to the assignments list associated with the task accordingly. Thus, task creation module 345 can be configured to check if compression is required according to the SLS (block 620), and if so, task creation module 345 can be configured to add the relevant assignment (e.g. compress data) to the assignments list (block 625). Task creation module 345 can be further configured to check if encryption is required according to the SLS (block 630), and if so, task creation module 345 can be configured to add the relevant assignment (e.g. encrypt data) to the assignments list (block 635).

Assuming that these are the only two assignments to be performed according to the SLS, task creation module 345 has successfully created the new task and the new task is ready for execution (block 640).

It is to be noted that, with reference to FIG. 7, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Following the brief explanation about tasks and their creation, attention is drawn to FIG. 8, showing a flowchart illustrating a sequence of operations carried out for managing a task received by a UDSP agent, according to certain examples of the presently disclosed subject matter.

In some cases, task management module 335 of UDSP agent 220 can be configured to receive a task (block 405). It is to be noted that a task can be received from a client server 218 (e.g. directly or through a gateway resource 216 that can act, inter alia, as a protocol converter), from a gateway resource 216, from another computer node 205, from an external entity (e.g. an application, etc.), or from any other source.

Following receipt of a task, task management module 335 can be configured to retrieve all or part of the data indicative of the dynamic behavior of all or part of the DSS 200 resources (e.g. computer nodes and/or storage-related resources, etc.) (block 410).

In some cases, task management module 335 can be configured to check if the task is associated with an SLS (e.g. the task relates to a specific logical storage entity, etc.) (block 412), and if so, retrieve the SLS associated with the logical storage entity associated with the task (e.g. from the UDSP data repository 330 or, if not available in UDSP data repository 330, from another computer node's UDSP data repository, etc.) (block 413).

Task management module 335 can be configured to utilize objective based routing module 395 to grade the suitability of one or more of the DSS 200 computer nodes 205 to execute one or more pending task assignments (block 415).

Pending task assignments are assignments that have no unfulfilled prerequisite prior to execution thereof. For example, a compression assignment can depend on prior execution of a deduplication assignment, an encryption assignment can depend on prior execution of a compression assignment, etc.

The suitability of computer nodes 205 to execute pending task assignments and thus, their grades, can be dependent for example on their resources (e.g. their processing capabilities), including their storage-related resources and/or, in case the task relates to a logical storage entity, on their ability to meet one or more SLS requirements (e.g. having a resource capable of being used for executing one or more of the task assignments in the scope of such a logical storage entity), if such requirements exist, and/or on their dynamic behavior and current state, etc. A more detailed description of the grading process is provided with respect to FIG. 9.

Based on the calculated grades, task management module 335 can be configured to utilize objective based routing module 395 to route the task for example to a more suitable computer node 205, and sometimes to the most suitable computer node, per grading results (e.g. the task can be routed to the computer node 205 having the highest grade) (block 420).

Task management module 335 can be configured to check if the task was routed to another computer node (block 425). If the task was routed to another computer node, then the process relating to the local computer node 205 (e.g. the computer node 205 running the process) ends (block 440). However, if the local computer node 205 is the most suitable one, then one or more of the pending task assignments can be executed on the local computer node 205 (block 430), for example by utilizing UDSP agent's 220 execution module 350.

It is to be noted that in some cases, not all pending task assignments that the local computer node 205 is capable of executing are executed by it, but only the pending task assignments for which it was selected as the most suitable one. Thus, for example, if a task comprises three pending task assignments, two of which can be executed by the local computer node 205, one for which it has the highest grade and one for which it does not have the highest grade—the UDSP agent 220 associated with the local computer node 205 can be configured to execute only the assignment for which the local computer node 205 has the highest grade. It is to be further noted that UDSP agent 220 of the local computer node 205 can in some cases utilize more than one processing resource of the local computer node 205 (if such exists) for parallel and/or concurrent processing of one or more assignments. In some cases, for such parallel and/or concurrent processing of more than one assignment, the local computer node 205 can utilize remote processing resources (e.g. processing resources associated with one or more remote computer nodes 205). A more detailed description of assignment/s execution is provided inter alia with respect to FIG. 10.

Task management module 335 can be further configured to check if additional assignments exist following execution of the assignments on the local computer node 205 and/or if the execution of the assignments on the local computer node 205 triggered creation of one or more new tasks (e.g. a replication assignment can result in generation of multiple write tasks, each destined at a different location) and/or assignments (block 435). If not—the process ends (block 440). If yes—the process returns to block 405, in which the task with the remaining assignments and/or the one or more new tasks are received by the UDSP agent 220 associated with the local computer node 205 and the processes of managing each of the tasks begin.

In some cases, the infrastructure layer can be updated, for example by adding one or more interconnected computer nodes 205 to the infrastructure layer, by removing one or more computer nodes 205 from the infrastructure layer, by modifying one or more existing computer nodes 205 (e.g. adding processing resources 310 and/or other storage related resources thereto, removing processing resources 310 and/or other storage related resources therefrom, etc.) of the infrastructure layer, etc. In some cases such changes to the infrastructure layer can be performed dynamically (e.g. whenever a user desires), including during operation of DSS 200.

Task management module 335 can in some cases be configured to utilize objective based routing module 395 to grade the suitability of one or more of the updated infrastructure layer computer nodes 205 that have been added or modified, to execute one or more pending task assignments of following tasks. In some cases, the updated infrastructure layer can be created during such grading calculation and the calculation can be performed in respect of one or more computer nodes 205 of the updated infrastructure layer. In some cases, the calculation can be performed in respect of one or more additional or modified computer nodes 205 of the updated infrastructure layer.

Task management module 335 can in some cases be configured to execute one or more of said pending assignments of following tasks or route said following tasks to a more suitable computer node 205 (and in some cases to the most suitable computer node 205) of the updated infrastructure layer, based on the calculated grades.

It is to be noted that, with reference to FIG. 8, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

As detailed herein, task management module 335 can be configured to utilize objective based routing module 395 to grade the suitability of one or more of the DSS 200 computer nodes 205 to execute pending task assignments. Attention is drawn to FIG. 9 illustrating a sequence of operations carried out for grading nodes suitability to execute pending task assignments, according to certain examples of the presently disclosed subject matter.

The grading process 700 can begin, for example, by objective based routing module 395 receiving at least one of: a task to be performed, data indicative of the dynamic behavior of all or part of the DSS 200 resources (including the computer nodes and/or the storage-related resources, etc.), or any other data that can be used by the grading process (block 710). In some cases, when the task is associated with a specific logical storage entity, objective based routing module 395 can also receive the SLS associated with the logical storage entity associated with the task.

Objective based routing module 395 can be configured to grade one or more computer nodes 205 suitability to execute each of the pending task assignments (block 720). The grading can be performed, inter alia, based on the received data.

It is to be noted that a grade can be calculated for each computer node 205 connected to DSS 200, or only for some of the computer nodes 205 (e.g. according to the network topology, the geographic distance from the local computer node 205, randomly and/or deterministically selecting computer nodes 205 until a sufficient number of computer nodes 205 suitable to execute one or more pending task assignments are found, etc.). It is to be further noted that various grading algorithms can be used for grading a computer node's 205 suitability to execute pending task assignments. It is to be still further noted that the grading process can contain and/or use heuristics and/or approximations. Additionally or alternatively, the grading can be based on partial and/or not up-to-date information.

In some cases, for each computer node 205 that a grade is to be calculated for, objective based routing module 395 can be configured to check, for each pending task assignment, if the computer node 205 can execute the pending task assignment. In case the task is associated with a logical storage entity, objective based routing module 395 can also check if the computer node 205 can execute the pending task assignment while meeting the requirements defined by the respective SLS. In case the computer node 205 cannot execute the pending task assignment (or cannot meet the requirements defined by the SLS when relevant), the grade for that node will be lower than the grade of a computer node 205 that is capable of executing the pending task assignment (while meeting the requirements defined by the SLS when relevant). In some cases, the grade is calculated also based on parameters data relating to one or more storage-related resources connected to the respective computer node 205 (e.g. data of parameters relating to presence and/or loads and/or availability and/or faults and/or capabilities and/or response time and/or connectivity and/or costs associated with the storage-related resources), and the capability of such storage-related resources to execute the pending task assignment (while meeting the requirements defined by the SLS when relevant).

In an exemplary manner, and for ease of understanding, the grade of a computer node 205 that cannot execute the pending task assignment (while meeting the requirements defined by the SLS, when relevant) is zero, whereas the grade of a computer node 205 that is capable of executing the pending task assignment (while meeting the requirements defined by the SLS when relevant) is greater than zero.

It is to be noted that in some cases, the calculated grades can be represented by non-scalar values, e.g. by multi-dimensional values. It is to be further noted that the calculated grades may not belong to an ordered set. It is to be still further noted that the decision of a suitable node and/or a most suitable node (e.g. the decision which grade is “higher”) can be arbitrary (e.g. when the grades do not belong to an ordered set, etc.).

In some cases, if the local computer node 205 suitability to execute the assignment would be identical to that of one or more remote computer nodes 205 if they all had identical communication costs of communicating the task thereto, the local computer node's 205 grade will be higher due to the costs associated with communicating the task to any remote computer node 205.

In some cases, for each computer node 205 that a grade is to be calculated for, objective based routing module 395 can be configured to calculate an integrated grade based on the grades calculated for each pending task assignment (block 730). Such an integrated grade can be, for example, a summary of the computer node's 205 assignments grades, an average of the computer node's 205 assignments grades, or any other calculation based on the calculated computer node's 205 assignments grades.

It is to be noted that, with reference to FIG. 9, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Turning to FIG. 10, there is shown an illustration of a sequence of operations carried out for executing pending task assignments on a computer node, according to certain examples of the presently disclosed subject matter.

As detailed herein, task management module 335 can be configured to utilize execution module 350 for performing an assignments execution process 800 for executing one or more of the pending task assignments. In such cases, execution module 350 can be configured to execute one or more pending task assignments (block 810).

As indicated herein, it is to be noted that in some cases, not all pending task assignments that the local computer node 205 is capable of executing are executed by it, but only the pending task assignments for which it was selected. In addition, it is to be further noted that UDSP agent 220 associated with the local computer node 205 can in some cases utilize more than one processing resource (if such exists) for parallel and/or concurrent processing of one or more assignments. In some cases, for such parallel and/or concurrent processing of more than one assignment, the local computer node 205 can utilize remote processing resources (e.g. processing resources associated with one or more remote computer nodes 205).

Following execution of the one or more pending task assignments, execution module 335 can be configured to update the statuses of the executed assignments to indicate that the assignments have been executed (block 820).

In some cases assignments can be partially executed or their execution can fail. In such cases, execution module 335 can be configured to update the assignment status with relevant indications. In some cases the statuses can also contain data of the execution results.

In some cases, execution module 335 can be configured to check if there is a need to check the current DSS 200 configuration (including, inter alia, the resources availability and allocation) (block 830). Such a need can exist, for example, in case the execution of one or more of the executed assignments that is associated with a logical storage entity did not meet (or came close to not meeting, e.g. according to pre-defined thresholds, etc.) the respective SLS requirements and/or if one or more assignments execution failed and/or if execution of an assignment results in change of data of parameters relating to computer nodes 205 and/or to resources connected thereto that exceeds a pre-defined or calculated threshold (such as shortage of storage space or any other resource, etc.) and/or for any other reason.

In case there is a need to check the current configuration of DSS 200, execution module 335 can be configured to recommend UDSP agents 220 associated with one or more computer nodes 205 to check if a reconfiguration is required (block 840). It is to be noted that in some cases the recommendation can be handled by objective based configuration module 390 of the UDSP agent 220 associated with the computer node 205 on which the one or more assignments are executed. In other cases, the recommendation can be sent to UDSP agents 220 associated with one or more computer nodes 205 that can be responsible for performing the reconfiguration process (e.g. dedicated computer nodes). A further explanation regarding the reconfiguration check is provided herein, inter alia with respect to FIG. 11.

In case there is no need to check the current configuration of DSS 200 or following the recommendation to check if a reconfiguration is required, execution module 335 can be configured to check if following execution of the one or more pending task assignments the task is finished (e.g. all of the assignments associated with the task have been executed) (block 850).

In case the task is not finished the process ends (block 860). If the task is finished, execution module 335 can be configured to check if any notification indicating that the task is finished is required (e.g. a notification to the task originator, etc.) (block 870). If no notification is required, the process ends (block 860). If a notification is required, execution module 335 can be configured to issue a notification of the task execution as required (block 880) and the process ends (block 860).

According to some examples of the presently disclosed subject matter, for each required notification a dedicated assignment of sending the required notification can be created, e.g. during the task creation process described herein. In such cases, optionally, blocks 850-880 can be disregarded.

It is to be noted that, with reference to FIG. 10, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 11, illustrating a sequence of operations carried out for managing reconfigurations of DSS, according to certain examples of the presently disclosed subject matter.

According to some examples of the presently disclosed subject matter, in some cases, a reconfiguration process 900 checking if a reconfiguration of DSS 200 is required can be performed. In some cases, such a check can be performed periodically (e.g. according to a pre-defined time interval, for example, every minute, every five minutes, every hour, or any other pre-defined time interval), continuously (e.g. in a repeating loop, etc.), following a triggering event (e.g. a monitored parameter exceeds a pre-defined or calculated threshold, receipt of a recommendation from a UDSP agent 220 associated with a computer node 205 as detailed inter alia with respect to FIG. 10, updating of one or more of the SLS requirements e.g. via a user interface as detailed inter alia with reference to FIG. 16, etc.), etc.

As indicated herein, in some cases, each UDSP agent 220 associated with a computer node 205 can be configured to perform the reconfiguration process 900, e.g. while utilizing objective based configuration module 390. In some cases, UDSP agents 220 associated with one or more computer nodes 205 (e.g. dedicated computer nodes) can be responsible for performing the reconfiguration process 900, e.g. while utilizing objective based configuration module 390.

In some cases, objective based configuration module 390 can be configured to receive any one of, or any combination of, SLSs associated with one or more logical storage entities in DSS 200, data indicative of the dynamic behavior of the DSS 200 and its resources and environment, data indicative of the current configurations of DSS 200, statistical data and historical data related to DSS 200, etc. (block 910). It is to be noted that in some cases all or part of the data can additionally or alternatively be retrieved from the UDSP data repository 330 associated with computer node 205 on which the reconfiguration process 900 is performed.

In some cases, objective based configuration module 390 can be configured to utilize the received data for checking if any of the SLSs are breached (or close to be breached, e.g. according to pre-defined thresholds, etc.) and/or if there is any other reason (e.g. a change in the SLS, a failure to perform one or more assignments irrespective of an SLS, etc.) for performing a reconfiguration of the DSS 200 (block 920).

It is to be noted that whereas in some cases, every time an SLS is breached (it should be noted that breach of an SLS can sometimes include nearing such a breach, e.g. according to pre-defined thresholds, etc.) a reconfiguration of DSS 200 can be initiated, in other cases such reconfiguration of DSS 200 can be initiated depending on meeting some pre-defined criteria. Such criteria can be, for example, a pre-defined number of detected SLS breaches required is to be met, either within a pre-defined time frame or irrespective of the time, etc. Thus, for example, exemplary criteria can be detection of three SLS breaches, or detection of three SLS breaches within one day, etc. In some cases, the importance of a breach can additionally or alternatively be considered as a criterion. For this purpose, objective based configuration module 390 can be configured to utilize the statistical data and historical data related to DSS 200.

In case there is a need to reconfigure DSS 200, objective based configuration module 390 can be configured to activate the Objective Based Management System (OBMS) 100 for performing a DSS 200 configuration process, as detailed above, inter alia with respect to FIGS. 2-4 (block 930). It is to be noted, as indicated herein, that in cases of reconfiguration of DSS 200, OBMS 100 can receive the current configurations of DSS 200 as part of the inputs for the configuration process and take it into consideration when reconfiguring DSS 200. In some cases, during such reconfiguration, OBMS 100 can be configured to reserve and/or allocate and/or reallocate and/or free all or part of the resources.

If no SLS is breached (or is close to be breached) and there is no other reason for performing a reconfiguration, or following initiation of a reconfiguration of DSS 200, reconfiguration process 900 ends (block 940).

It is to be noted that, with reference to FIG. 11, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 12, illustrating a sequence of operations carried out for monitoring local parameters of a computer node and resources connected thereto, according to certain examples of the presently disclosed subject matter.

In some cases, local parameters monitoring module 360 can be configured to monitor various parameters of a computer node 205 and/or storage-related resources connected thereto (block 1010). As indicated herein, the monitored parameters can be any parameters indicative of presence and/or loads and/or availability and/or faults and/or capabilities and/or response time and/or connectivity and/or costs (e.g. costs of network links, different types of data storage resources) and/or any other parameters indicative of the dynamic behavior of the computer node 205 and/or any storage-related resource connected thereto and/or any other data relating to the computer node 205 and/or to one or more of the storage-related resources connected thereto. In some cases, local parameters monitoring module 360 can be configured to monitor various parameters of a client server 218 and/or a gateway resource 216, mutatis mutandis.

It is to be noted that such monitoring can be performed periodically (e.g. according to a pre-defined time interval, for example, every minute, every five minutes, every hour, or any other pre-defined time interval), continuously (e.g. in a repeating loop, etc.), following a triggering event (e.g. connection of a new resource to the computer node 205, etc.), etc.

In some cases, local parameters monitoring module 360 can be configured to check if a new parameter or a change in the value of any of the monitored parameters was detected (block 1020). If not, local parameters monitoring module 360 can be configured to continue monitoring parameters. If, however, a new parameter or a change in the value of any of the monitored parameters has been detected, local parameters monitoring module 360 can be configured to propagate (e.g. while utilizing multicast module 340) notifications indicative of a change to one or more local parameters. In some cases, such notifications can be sent to one or more computer nodes 205 and/or client servers 218 and/or gateway resources 216 (e.g. by unicast/multicast/recast transmission) (block 1030).

It is to be noted that in some cases, local parameters monitoring module 360 can be configured to send various types of notifications that can comprise various indications (e.g. indications of various groups of one or more local parameters, etc.) in various pre-determined time periods or in response to various triggering events. It is to be further noted that some notifications can be selectively sent, for example to one or more computer nodes 205 that registered to receive such notifications.

In some cases, local parameters monitoring module 360 can be configured to update the parameter value, and in some cases additionally or alternatively, derivatives thereof (e.g. various statistical data related to the parameter) in UDSP data repository 330 (block 1040).

In some cases, local parameters monitoring module 360 can be configured to check if there is a need to check the current DSS 200 configuration. Such a need can exist, for example, in case one of the monitored parameters exceeded a pre-defined or calculated threshold associated therewith and/or for any other reason.

In case there is a need to check the current configuration of DSS 200, local parameters monitoring module 360 can be configured to recommend UDSP agents 220 associated with one or more computer nodes 205 to check if a reconfiguration is required. It is to be noted that in some cases the recommendation can be handled by objective based configuration module 390 of the UDSP agent 220 associated with the local computer node 205 on which the local parameters monitoring module 360 is running, In other cases, the recommendation can be sent to UDSP agents 220 associated with one or more computer nodes 205 that can be responsible for performing the reconfiguration process (e.g. dedicated computer nodes). A further explanation regarding the reconfiguration check is provided herein, inter alia with respect to FIG. 11.

It is to be noted that, with reference to FIG. 12, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 13, illustrating a sequence of operations carried out for detecting and managing resources connected to a computer node, according to certain examples of the presently disclosed subject matter.

In some cases, resource detection and management module 385 can be configured to perform a detection and management process 1200. In some cases resource detection and management module 385 can be configured to scan for storage-related resources connected to one or more computer nodes 205 (block 1210). In some cases, resource detection and management module 385 can be configured to perform the scan continuously and/or periodically (e.g. every pre-determined time period, for example every minute, every five minutes, every hour, etc.), etc. In some case, the scan can be initiated by a user (e.g. a system administrator, etc.).

Resource detection and management module 385 can be configured to check if any new storage-related resource is found (block 1220). If no new storage-related resource is found, resource detection and management module 385 can be configured to continue scanning for storage-related resources. If one or more new storage-related resources are found, storage-related resource detection and management module 385 can be configured to check if there is a need in one or more plug-ins for using such a storage-related resource and if so whether the plug-ins exist locally (e.g. on the computer node 205 to which the new resource is attached/connected) (block 1230).

If there is a need for one or more plug-ins and they all exist locally, resource detection and management module 385 can be configured to associate the plug-ins with the new storage-related resource and the storage-related resource can be added to the local resource pool (block 1240).

If there is a need for one or more plug-ins that do not exist locally, resource detection and management module 385 can be configured to check if the one or more missing plug-ins exist, for example on one or more computer nodes 205 and/or client servers 218 and/or gateway resources 216 (e.g. while utilizing multicast module 340) and/or in a shared virtual software extensions library as detailed herein (block 1250) and/or on any other location on DSS 200, and/or on any auxiliary entity.

If resource detection and management module 385 found the required plug-ins, resource detection and management module 385 can be configured to associate the plug-ins with the new storage-related resource and the storage-related resource can be added to the local resource pool (block 1240).

In some cases, if resource detection and management module 385 did not find the required plug-ins, resource detection and management module 385 can be configured to issue one or more plug-in requests. Such plug-in requests can in some cases be sent to a user (block 1270), thus enabling such a user to add the relevant plug-ins to DSS 200 (e.g. after purchasing it, downloading it from the Internet, etc.). Following sending such a request, resource detection and management module 385 can be configured to continue scanning for storage-related resources (block 1210).

It is to be noted that in some cases, until the required plug-ins are found, retrieved (if required) and installed, the new storage-related resource can be marked as a new storage-related resource that is identified every time a scan for storage-related resources is performed and thus, the process detailed herein repeats until the required plug-ins are found.

In some cases, resource detection and management module 385 can be additionally or alternatively configured to check if a storage-related resource removal is detected following the scan for storage-related resources (block 1280). In such cases, if a storage-related resource removal is detected, resource detection and management module 385 can be configured to remove the storage-related resource from the local resource pool and, optionally, clean up any plug-ins that are no longer required (e.g. in light of the fact that the resource that utilized such plug-ins is removed) (block 1290).

It is to be noted that in some cases, resource detection and management module 385 can be additionally or alternatively configured to perform the detection and management process 1200 for storage-related resources connected/disconnected to/from one or more client servers 218 and/or gateway resources 216, mutatis mutandis. It is to be further noted that utilization of the resource detection and management module 385 can enable seamless addition and/or removal and/or attachment and/or detachment of storage-related resources to computer nodes 205 and/or to client servers 218 and/or gateway resources 216 (e.g. “plug and play”), including during operation of DSS 200, and in some cases without performing any management action by a user (including, inter alia, any preliminary management action).

It is to be further noted that in some cases, addition and/or removal of storage-related resources to/from the local resource pool can result in changes to the monitored local parameters of a computer node 205 (e.g. addition and/or removal and/or update and/or any other change of various local parameters). As indicated herein, when new parameters are detected, in some cases, appropriate notifications can be sent by local parameters monitoring module 360, as detailed herein inter alia with respect to FIG. 12. It is to be noted that in some cases such notifications can trigger reconfiguration.

It is to be noted that, with reference to FIG. 13, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 14, illustrating a sequence of operations carried out for connecting a new computer node to Distributed Storage System (DSS), according to certain examples of the presently disclosed subject matter.

In some cases, when a new computer node 205, comprising a UDSP agent 220 connects to a network, cloud plug and play module 380 of the new computer node 205 can be configured to detect a new network connection and/or a change to an existing network connection (e.g. that the computer node 205 on which cloud plug and play module 380 is connected to a new or to a different network) (block 1305). Following detection of a new network connection, cloud plug and play module 380 can be configured to send (e.g. by unicast/multicast/recast transmission) a discovery message, for example by utilizing multicast module 340 (block 1310). Such discovery message can trigger any receiving computer node 205 to respond, e.g. by sending a response including at least a DSS 200 identifier (each DSS 200 can have a unique identifier that enables identification thereof).

Cloud plug and play module 380 can be configured to listen for any response received within a pre-determined time interval (e.g. a time interval that can enable the receiving computer nodes 205 to respond to the discovery message) and check if any response was received (block 1315). If no response was received, and computer node 205 did not join a DSS 200, cloud plug and play module 380 can be configured to repeat block 1310 and resend a discovery message.

If a response was received, cloud plug and play module 380 can be configured to check if the responses refer to a single DSS 200 (e.g. according to the received DSS 200 identifiers) (block 1320). If so, cloud plug and play module 380 can be configured to join computer node 205 to the detected DSS 200 (block 1325). It is to be noted that as a result of joining a DSS 200, computer node 205 can automatically begin sending and receiving various notifications, as detailed herein.

If more than one DSS 200 is detected (e.g. more than one DSS 200 identifier is received as a response to the discovery message), cloud plug and play module 380 can be configured to check if a default DSS 200 exists (block 1330). For this purpose, in some cases, an indication of a default DSS 200 can be retrieved from a local registry (e.g. a data repository accessible on the local network), from a Domain Name System (e.g. under a pre-defined DNS record, etc.), etc. In some cases an indication of a default DNS 200 can be sent by one of the responding computer nodes 205 whose response can include an indication of the default DSS 200. It is to be noted that other methods and techniques for identifying a default DSS 200 can be used as well.

If such default DSS 200 exists, cloud plug and play module 380 can be configured to join computer node 205 to the default DSS 200 (block 1325). If no default DSS 200 is detected, an indication of the new computer node 205 can be provided to a user for its selection of the DSS 200 to which the new computer node 205 is to join, and cloud plug and play module 380 can be configured to wait for such selection (block 1335). Once a selection is made, cloud plug and play module 380 can be configured to join computer node 205 to the selected DSS 200 (block 1325).

In some cases, upon detection of a new network connection (block 1305), cloud plug and play module 380 can be additionally or alternatively configured to look up a local registry (e.g. a data repository accessible on the local network) and/or a global registry (e.g. a data repository accessible on the Internet) registry service, for example on a pre-defined network address and/or on a directory service (e.g. DNS, Active Directory, etc.) (block 1340). Such registry service can enable inter alia identification of available DSS's 200 and/or a default DSS 200.

Cloud plug and play module 380 can be configured to check if a local registry is found (block 1345), and if so, it can be configured to register on the local registry (if it is not already registered) (block 1355). Such registration can include storing various configuration parameters related to the local computer node 205 in the registry. Cloud plug and play module 380 can be further configured to check if a policy defined by the local registry allows global registration (block 1355). If so, or in case that no local registry is found, cloud plug and play module 380 can be configured to check if a global registry is found (block 1360). If so—cloud plug and play module 380 can be configured to register on the global registry (if it is not already registered) (block 1365). Such registration can include storing various configuration parameters related to the local computer node 205 in the registry.

Following registration on the global registry or in case the policy defined by the local registry does not allow global registration, cloud plug and play module 380 can be configured to jump to block 1320 and continue from there.

It is to be noted that other methods can be used in order to join a new computer node 205 to a DSS 200, both automatically and manually, and the methods provided herein are mere examples.

It is to be noted that utilization of the cloud plug and play module 380 can enable computer nodes 205 to be seamlessly added and/or removed and/or attached and/or detached from the network, at any time, including during operation of DSS 200, and in some cases without performing any management action by a user (including, inter alia, any preliminary management action), provided that a UDSP agent 220 is installed on the computer node 205 (a detailed description of a UDSP agent 220 is provided herein). It is to be further noted that optionally, following addition and/or removal and/or attachment and/or detachment of one or more computer nodes 205 from the network, no user is required for enabling continued operation of the DSS 200.

It is to be noted that, with reference to FIG. 14, some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 15, illustrating a sequence of operations carried out for receiving a notification from a remote computer node and updating a Unified Distributed Storage Platform (UDSP) data repository accordingly, according to certain examples of the presently disclosed subject matter.

In some cases, remote nodes parameters monitoring module 370 of a UDSP agent 220 of a computer node 205 can be configured to receive various notifications (general notifications and/or notifications originating from a source to which computer node 205 registered in order to receive messages from) originating from other computer nodes 205 and/or client servers 218 and/or gateway resources 216 and/or users, etc. (block 1410).

In some cases, remote nodes parameters monitoring module 370 can be configured to update UDSP data repository 330 accordingly (block 1420).

It is to be noted that such data stored in UDSP data repository 330 can be used in order to locally maintain knowledge of the DSS 200 state (e.g. its dynamic behavior, etc.) or parts thereof which are relevant for the processes carried out by the computer node 205, as detailed herein.

It is to be noted, with reference to FIG. 15, that some of the blocks can be integrated into a consolidated block or can be broken down to a few blocks and/or other blocks may be added. Furthermore, in some cases, the blocks can be performed in a different order than described herein. It should be also be noted that whilst the flow diagrams are described also with reference to the system elements that realizes them, this is by no means binding, and the blocks can be performed by elements other than those described herein.

Attention is now drawn to FIG. 16, illustrating a sequence of operations carried out for generating a user interface for receiving user input defining SLS requirements and configuring a Distributed Storage System (DSS) accordingly, according to certain examples of the presently disclosed subject matter.

In some cases, UI module 387 of a UDSP agent 220 of a computer node 205 can be configured to generate a user interface for presentation to a user (e.g. a system administrator) for enabling performance of administration of the DSS 200 (block 1510). The generated user interface can include one or more portions, each comprising a control (e.g. a slider, a checkbox, a picker, a list box, a radio button, a combo box, a text box or any other type of control) for receiving user input relating to a certain SLS requirement of a certain SLS (relating to one or more logical storage entities of DSS 200). A non-limiting example of such a user interface is provided herein, with reference to FIG. 17.

UI module 387 can be further configured to output the generated user interface for display to a user (e.g. using a screen or any other means that can display the user interface to the user) (block 1520), and to receive user input defining values for the user inputs relating to the respective SLS requirement (block 1530).

In some cases, following receipt of the user input, the DSS 200 can be configured to automatically perform a reconfiguration process (e.g. while utilizing objective based configuration module 390) transforming the state of the DSS 200 from a first state to a second state, based on the received user input (block 1540). In case there is a need to reconfigure DSS 200 (e.g. as one or more SLS requirements changed, etc.), objective based configuration module 390 can be configured to activate the Objective Based Management System (OBMS) 100 for performing a DSS 200 configuration process, as detailed above, inter alia with respect to FIGS. 2-4. It is to be noted, as indicated herein, that in cases of reconfiguration of DSS 200, OBMS 100 can receive the current configurations of DSS 200 as part of the inputs for the configuration process and take it into consideration when reconfiguring DSS 200. In some cases, during such reconfiguration, OBMS 100 can be configured to reserve and/or allocate and/or reallocate and/or free all or part of the resources.

It is to be noted that in some cases, UI module 387 can be configured to output the generated user interface for display to a user (e.g. a system administrator, etc.) in a single user interface and the user input is received via the single user interface. Looking at a non-limiting example, the user input can relate to one or any combination of two or more of the following SLS requirements (a non-limiting list):
1. A Required storage capacity;
2. A Maximal allowed latency (response time);
3. A recovery point objective (RPO);
4. A recovery time objective (RTO);
5. A backup retention policy defining for how long information should be retained;
6. A minimal required throughput;
7. Minimal required IOPS (Input/Output operations per second);
8. A minimal required compression level indicative of the minimal required compression of data;
9. A number of required Disaster Recovery sites;
10. A storage method (physical capacity, thin capacity/provisioning);
11. A local availability level indicative of a required minimal probability of availability of the information stored in the logical storage entity associated with the SLS (minimal up-time expectancy of the information stored in the logical storage entity);
12. A global availability level indicative of a required minimal probability of availability of the information stored in one or more of the DR sites (minimal up-time expectancy of the information stored in the DR sites);
13. A required number (or a minimal and maximal number) of physical copies of stored data.
14. A required location definition (definition or rules) for one or more of the stored data copies.
15. A required encryption (e.g. an indication whether to encrypt data or not, what type of encryption to use, or any other encryption related parameter).
16. A required deduplication (e.g. an indication whether to deduplicate data or not, what type of deduplication to use, or any other deduplication related parameter).
17. A maximal allowed over-allocation, if any.
18. A minimal thin capacity allocation indicating how much storage to allocate in advance if and when the storage method is thin capacity.

It is to be noted that the above mentioned parameters can relate to a primary storage site (a storage site that is housing one or more computer systems that directly interact with one or more logical storage entities of the DSS 200), and/or to any one, or any two or more, of the DR storage sites of DSS 200, and in some cases to the entire DSS 200.

It is to be noted that in some cases, the RPO and/or RTO can be time dependent. Thus, for example, the RPO and/or RTO for data stored recently (e.g. in a certain time window of several seconds/minutes/hours/days/weeks/months/years, e.g. 4 hours) can be higher than the RPO and/or RTO for data stored prior to it. For example (non-limiting) the RPO and/or RTO for the time window of 0-4 hours can be higher than the RPO and/or RTO for the time window of 4-12 hours, that in turn can be higher than the RPO and/or RTO for the time window of 12-24 hours, that in turn can be higher than the RPO and/or RTO for the time window of 24 hours—one week, that in turn can be higher than the RPO and/or RTO for the time window of one week—one month, that in turn can be higher than the RPO and/or RTO for the time window of one month—one year, that in turn can be higher than the RPO and/or RTO for the time window of more than one year.

Attention is drawn to FIG. 17, illustrating an exemplary user interface used for administration of a distributed storage system, according to the presently disclosed subject matter.

It can be appreciated that the exemplary user interface 1600 comprises a plurality of portions of a user interface for presentation to a user, each of these portions comprising a control for receiving a Service Level Specification (SLS) requirement from a user. In the exemplary user interface 1600, portion 1610 comprises a control for receiving a required storage capacity; portion 1615 comprises two portions, 1620 and 1625, comprising controls for receiving a maximal allowed latency (response time) and a minimal required throughput or Minimal required IOPS (e.g. depending on the selection in the checkbox within portion 1625), respectively; portion 1630 comprises a control for receiving a backup retention policy defining for how long information should be retained; portion 1635 comprises a control for receiving a recovery point objective; portion 1640 comprises a control for receiving a number of required Disaster Recovery sites; portion 1645 comprises a control for receiving a required number of copies of stored data.

In some cases, the exemplary user interface 1600 further comprises a plurality of portions of a user interface for presentation to a user, each of these portions comprising a control for displaying information to the user about the current values of the SLS requirements. In the exemplary user interface 1600, portion 1650 comprises a control for displaying information of the current value of the required storage capacity; portion 1655 comprises a control for displaying information of the current maximal allowed latency (response time); portion 1660 comprises a control for displaying information of the minimal required throughput, respectively; portion 1665 comprises a control for displaying information of the current backup retention policy defining for how long information should be retained; portion 1670 comprises a control for displaying information of the current recovery point objective; portion 1675 comprises a control for displaying information of the current number of required Disaster Recovery sites; portion 1680 comprises a control for displaying information of the current required number of copies of stored data.

In some cases, the exemplary user interface 1600 can further comprise a portion of user interface comprising a control 1685 for displaying information to the user about some of the requirements that the DSS 200 is required to meet, based, inter alia, on the SLS requirements (e.g. required CPU, required cache, required storage capacity, etc.). In some cases, the exemplary user interface 1600 can further comprise a portion of user interface comprising a control 1690 for displaying information to the user about some of the available DSS 200 resources (e.g. CPU, cache, storage capacity available on the DSS 200 storage-related resources such as disks, etc.). In some cases, the exemplary user interface 1600 can further comprise a portion of user interface comprising a control 1695 for displaying information to the user about the name of the logical storage entity to which the SLS requirements relate. In some cases, the exemplary user interface 1600 can further comprise a portion of user interface comprising a control 1697 for displaying information to the user about the identity of the primary storage site (a storage site that is housing one or more computer systems that directly interact with one or more logical storage entities of the DSS 200).

It is to be noted, with respect to the exemplary user interface 1600, that although the controls are of a certain type (e.g. a slider, a slider, a checkbox, a picker, a list box, a radio button, a combo box, a text box, etc.), any other type of control can be used mutatis mutandis.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. One or more tangible computer readable media storing computer executable instructions that, when executed by a processor, cause a computer node connected to an infrastructure layer of a distributed storage system, said infrastructure layer including interconnected computer nodes, at least one of said interconnected computer nodes comprising one or more storage-related resources, to perform administration of a distributed storage system by:
generating at least one portion of a user interface for presentation to a user, each of said portions comprising a control for receiving a Service Level Specification (SLS) requirement, wherein one or more of said SLS requirements relate to a distinct one of the following: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies;
transforming a state of the distributed storage system from a first state to a second state based on the received SLS requirements.

2. The computer readable media of claim 1, wherein said transforming comprises:
calculating a reconfiguration for the distributed storage system, based, at least, on said SLS requirements; and
automatically allocating at least part of one of said storage-related resources according to the calculated reconfiguration.

3. The computer readable media of claim 1, wherein said computer executable instructions further cause the computer node to perform administration of the distributed storage system by:
outputting the at least one portion for display to the user; and
receiving user input defining values for each of the SLS requirements.

4. The computer readable media of claim 1, wherein outputting comprises outputting the at least one portion for display to the user in a single user interface, and wherein the received SLS requirements are received via the single user interface.

5. A Distributed Storage System (DSS) comprising at least two logical storage entities, wherein each logical storage entity is configured in accordance with Service Level Specification (SLS) requirements, and wherein the DSS is configured to a first state, wherein a first logical storage entity is associated with first SLS requirements, and wherein a second logical storage entity is associated with second SLS requirements;
the DSS further comprising:
an infrastructure layer including interconnected computer nodes, wherein:
each one of said interconnected computer nodes comprising at least one processing resource configured to execute a Unified Distributed Storage Platform (UDSP) agent;
at least one of said interconnected computer nodes comprising one or more storage-related resources;
said UDSP agent is configured to:
receive an input defining third SLS requirements, wherein said inputs is received via a configuration user interface that displays a plurality of input controls, each input control corresponding to an SLS requirement of said SLS requirements, wherein at least one of said SLS requirements relate to a distinct one of the following: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies; and
automatically transform the distributed storage system to a second state, wherein the first logical storage entity is configured in accordance with the third SLS requirements, and wherein the second logical storage entity is configured in accordance with the second SLS requirements.

6. The system of claim 5, wherein the configuration user interface concurrently displays the plurality of input controls.

7. A method of operating a computer node configured to being connected to an infrastructure layer of a distributed storage system (DSS) configured to a first state, said infrastructure layer including interconnected computer nodes, at least one of said interconnected computer nodes comprising one or more storage-related resources, wherein said DSS provides storage service to a plurality of users, wherein the storage service for each of the users is provided in accordance with a plurality of Service Level Specification (SLS) requirements, the method comprising:
receiving user input defining an updated value for one or more of the plurality of SLS requirements associated with a first user of the plurality of users; and
automatically transforming the distributed storage system to a second state wherein the storage service of the first user is modified based on the received user input, and wherein the storage service of a second user remains unchanged from the first state.

8. The method of claim 7, wherein said transforming comprises:
calculating a reconfiguration for the distributed storage system, based, at least, on the received user input; and
automatically allocating at least part of one of said storage-related resources according to the calculated reconfiguration.

9. The method of claim 7, wherein the plurality of SLS requirements comprise one or more of: a required storage capacity, a maximal allowed latency, a recovery point objective, a recovery time objective, a backup retention policy, a minimal required throughput, minimal required input/output operations per second, a minimal required compression level, a number of required Disaster Recovery sites, a storage method, a local availability level, a global availability level, a required encryption, a required deduplication, a maximal allowed over-allocation, a minimal thin capacity allocation, a required number of copies of stored data, a required location definition for one or more of the stored data copies.
